(19) United States
(12) Patent Application Publication
(10) Pub. No.: US 2023/0279612 A1
(43) Pub. Date: Sep. 7, 2023

(54) MOBILE DISPERSION SYSTEM AND METHODS FOR THE RESUSPENSION OF DRIED MICROFIBRILLATED CELLULOSE

(71) Applicant: FIBERLEAN TECHNOLOGIES LIMITED, Par (GB)

(72) Inventors: Paymaan TAHAMTAN, Par (GB); Mark WINDEBANK, Par (GB); David R. SKUSE, Par (GB)

(73) Assignee: FIBERLEAN TECHNOLOGIES LIMITED, Par (GB)

(21) Appl. No.: 17/939,365

(22) Filed: Sep. 7, 2022

Related U.S. Application Data
(63) Continuation of application No. PCT/US2022/042713, filed on Sep. 7, 2022.
(60) Provisional application No. 63/241,700, filed on Sep. 8, 2021.

(51) Int. Cl. D21C 9/00; D21H 11/18; D21H 17/67; D21H 21/20

(52) U.S. Cl. CPC D21C 9/007; D21H 11/18; D21H 17/675; D21H 21/20

(57) ABSTRACT

A transportable system (1) for re-dispersing an essentially-dried or partially-dried and, optionally, pulverized composition comprising microfibrillated cellulose and, optionally, one or more inorganic particulate material in a liquid medium to form a liquid composition, and associated methods to produce a substantially homogeneous (uniform) re-dispersed suspension of microfibrillated cellulose and, optionally, one or more inorganic particulate material; wherein the tensile index of the microfibrillated cellulose is comparable to the tensile index of a comparable never-dried suspension of microfibrillated cellulose and, optionally, one or more inorganic particulate material.

### FIELD OF INVENTION

The present invention relates generally to transportable equipment systems and associated methods for re-dispersing previously essentially-dried or partially-dried and, optionally, pulverized, compositions comprising microfibrillated cellulose and, optionally, one or more inorganic particulate material.

### BACKGROUND OF INVENTION

Transportable equipment systems of the type described herein require reduced energy input to re-disperse previously essentially-dried or partially-dried and, optionally, pulverized, compositions comprising microfibrillated cellulose and, optionally, one or more inorganic particulate material, as a substantially homogeneous suspension for end-use applications. The described transportable equipment systems minimize or avoid agglomeration and/or hornification normally associated with the re-dispersion of microfibrillated cellulose. The equipment systems and associated methods also restore optimal tensile properties, including tensile strength and tensile index, of the re-dispersed microfibrillated cellulose in various end-use applications in which such re-dispersed compositions of microfibrillated cellulose and, optionally, one or more inorganic particulate material compositions are utilized. The described equipment systems also address the need for transportable mobile equipment systems which may be installed at remote end-user locations.

The present invention also relates generally to methods of improving the redispersibility of dried and pulverized compositions comprising microfibrillated cellulose and, optionally, one or more inorganic particulate material. The described methods comprise preparation of slurries of compositions comprising previously essentially-dried or partially-dried and, optionally, pulverized, microfibrillated cellulose and, optionally, one or more inorganic particulate material, wherein the slurry of microfibrillated cellulose and one or more inorganic particulate material can be re-dispersed in a single pass, while requiring reduced energy input to re-disperse the microfibrillated cellulose and, optionally, one or more inorganic particulate material composition. The described methods minimize or eliminate agglomeration and/or hornification of the microfibrillated cellulose upon re-dispersion. The described methods also restore optimal tensile properties, including tensile strength and tensile index properties, of the re-dispersed microfibrillated cellulose.

Microfibrillated cellulose and inorganic particulate materials, for example an alkaline earth metal carbonate (e.g., calcium carbonate) or kaolin clay, are used widely in a number of applications. These include the production of microfibrillated cellulose and inorganic particulate material-containing compositions, which may be used as fillers in paper manufacture and/or in paper coatings, for example, in accordance with U.S. Pat. Nos. 8,231,764; 9,127,405; and 10,100,464, which are hereby incorporated by reference in their entirety. In paper and coated paper products, such fillers are typically added to replace a portion of other more expensive components of the paper and/or coated paper product. Fillers may also be added with an aim of modifying the physical, mechanical, and/or optical requirements of paper and/or coated paper products, for example in the manner described in U.S. Pat. No. 10,253,457, which is hereby incorporated by reference in its entirety. Clearly, the greater the amount of filler that can be included, the greater potential for cost savings. However, the amount of filler added and the associated cost saving must be balanced against the physical, mechanical and optical requirements of the final paper product or coated paper product. Thus, there is a continuing need for the development of improved fillers for paper and paper coatings, which can be used at a high loading level without adversely affecting the physical, mechanical and/or optical requirements of such paper and/or coated paper products. There is also a need for the development of methods for preparing such fillers economically

In recent years, microfibrillated cellulose and compositions comprising same as well as compositions comprising microfibrillated cellulose and one or more inorganic particulate material have been shown to have a variety of useful properties, including the enhancement of the mechanical, physical and/or optical properties, of a variety of end-use products, such as paper, paperboard, polymeric articles, paints, and the like.

Typically prepared in aqueous form, microfibrillated cellulose compositions are frequently dried for transport in order to reduce the overall weight of the compositions as well as to reduce associated transportation costs. The end-user will then typically re-disperse the microfibrillated cellulose prior to use in an intended end-use application. Exemplary processes for dewatering and drying compositions comprising microfibrillated cellulose and one or more inorganic particulate material are described in U.S. Pat. No. 11,001,644, which is incorporated herein in its entirety. However, following drying and re-dispersion some or all of the advantageous properties of the microfibrillated cellulose can be diminished or lost, for reasons that include agglomeration and/or hornification of the microfibrillated cellulose. Thus, there is an ongoing need to improve the properties of microfibrillated cellulose following drying and re-dispersion.

### SUMMARY OF THE INVENTION

The present invention seeks to address the problem of re-dispersing a dewatered, and optionally, pulverized, essentially-dried or partially-dried composition comprising microfibrillated cellulose and, optionally, comprising one or more inorganic particulate matter compositions in a dispersing liquid, optionally in the presence of an additive other than inorganic particulate material and/or in the presence of a combination of inorganic particulate materials, while avoiding the well-known problems of agglomeration and/or hornification. The additive and/or combination of inorganic particulate materials may, for example, enhance a mechanical and/or physical property of the re-dispersed microfibrillated cellulose. The present invention further relates to compositions comprising re-dispersed microfibrillated cellulose and the use of re-dispersed microfibrillated cellulose in an article, product or composition.

The present invention seeks to provide alternative and/or improved fillers for paper and/or coated paper products which may be incorporated in the paper and/or coated paper product at relatively high loading levels, whilst maintaining or even improving the physical, mechanical and/or optical properties of the paper and/or coated paper product.

The present invention also seeks to provide an economical method and corresponding portable manufacturing system for re-dispersing a composition comprising microfibrillated cellulose and, optionally, one or more inorganic particulate material for preparing such fillers comprising same for a variety of end-use applications, as described more completely herein. Such portable systems allow construction of a system for re-dispersing an essentially-dried or partially-dried composition comprising microfibrillated cellulose and, optionally, one or more inorganic particulate material at a location proximate to an end-use manufacturing site, for example, a paper manufacturing and/or a paper coating site.

The solution to the problem is a transportable system for re-dispersing previously essentially-dried or partially-dried and, optionally, pulverized, compositions comprising microfibrillated cellulose and one or more inorganic particulate material, and associated methods for the re-dispersion of a previously essentially-dried or partially dried and, optionally, pulverized, composition comprising microfibrillated cellulose and, optionally, one or more inorganic particulate material, as described in detail in the present specification.

Transportable re-dispersion systems of the type described comprise: a mixing apparatus comprising a shear-head impeller to partially de-agglomerate the microfibrillated cellulose and, optionally, one or more inorganic particulate material, to form a flowable slurry (i.e., a liquid suspension); a first stage high-shear rotor-stator apparatus (for example a Trigonal® mill, a colloid mill, an ultrafine grinding apparatus or a refiner), wherein the flowable slurry of microfibrillated cellulose and, optionally, one or more inorganic particulate material is subjected to further high-shear mixing to form a substantially homogenous suspension of microfibrillated cellulose and, optionally, one or more inorganic particulate material; optionally, a hydrocyclone for separating the substantially homogeneous suspension of microfibrillated cellulose and, optionally, one or more inorganic particulate material into a sheared fine particle stream and an under-sheared coarse particle stream, comprising a recirculation loop for returning the under-sheared coarse particle stream to the mixing apparatus for further moderate-shear mixing and flowing the fine particle stream to a second stage high-shear apparatus (for example, a rotor-rotor apparatus, a second high-shear rotor-stator apparatus, a colloid mill, an ultrafine grinding apparatus, or a refiner) for subjecting the substantially homogenous suspension to additional high-shear processing to produce a uniform re-dispersed suspension of microfibrillated cellulose and, optionally, one or more inorganic particulate material; wherein the tensile properties of the microfibrillated cellulose are comparable to the tensile properties of a comparable never-dried suspension of microfibrillated cellulose and, optionally, one or more inorganic particulate material; and collecting the re-dispersed suspension of microfibrillated cellulose and, optionally, one or more inorganic particulate material in a suitable holding vessel for further end-use application.

The rotor-rotor high-shear apparatus comprises counter-rotating rings for subjecting the fine particle stream to high-shear processing to produce a substantially homogeneous or uniform re-dispersed suspension of microfibrillated cellulose and, optionally, one or more inorganic particulate material, wherein the tensile properties of the microfibrillated cellulose are comparable to the tensile strength of a comparable never-dried suspension of the microfibrillated cellulose and one or more inorganic particulate material. The system comprises a suitable holding vessel to collect the re-dispersed suspension of microfibrillated cellulose and one or more inorganic particulate material in a suitable holding vessel for further end-use applications.

Associated methods comprise re-dispersion of a previously essentially-dried or partially-dried and, optionally, pulverized, composition comprising microfibrillated cellulose and, optionally, one or more inorganic particulate material. The methods comprise the following embodiments and steps.

A method for the re-dispersion of an essentially-dried or partially-dried and, optionally, pulverized, composition comprising microfibrillated cellulose and, optionally, one or more inorganic particulate material; the method comprising the steps of:
(a) providing a quantity of a dispersing liquid to a mixing tank through a first inlet; wherein the mixing tank comprises a moderate-shear mixing apparatus comprising a shear-head impeller and; wherein the mixing tank further comprises an outlet, and a first pump attached to the outlet;
(b) providing a quantity of essentially-dried or partially-dried and, optionally, pulverized, composition comprising microfibrillated cellulose and, optionally, one or more inorganic particulate material, to the mixing tank through the first inlet in sufficient quantity to yield a liquid slurry at a solids content of from about 0.5 wt% to about 5 wt% fibre solids;
(c) mixing the liquid slurry under moderate-shear conditions via the mixing apparatus to partially de-agglomerate the liquid slurry to form a flowable slurry;
(d) pumping the flowable slurry via the pump attached to the first outlet of the mixing tank to an inlet of a first stage high-shear rotor-stator apparatus further comprising an outlet, and a pump attached to the outlet; wherein the inlet of the first stage high-shear rotor-stator apparatus is in communication with the outlet of the mixing tank; wherein the flowable slurry is subjected to high-shear mixing to form a substantially homogenous suspension;
(e) pumping the substantially homogenous suspension from the outlet of the first stage high-shear rotor-stator apparatus to an inlet of a second stage high-shear apparatus, selected from a rotor-rotor apparatus, a second high-shear rotor-stator apparatus, a colloid mill, an ultrafine grinding apparatus, or a refiner, wherein the rotor-rotor apparatus comprises counter-rotating rings, for subjecting the substantially homogenous suspension to additional high-shear processing to produce a uniform re-dispersed suspension of microfibrillated cellulose and, optionally, one or more inorganic particulate material; wherein the tensile index of the microfibrillated cellulose is comparable to the tensile index of a comparable never-dried suspension of microfibrillated cellulose and, optionally, one or more inorganic particulate material; and
(h) collecting the re-dispersed suspension of microfibrillated cellulose and, optionally, one or more inorganic particulate material in a suitable holding vessel for further end-use applications.

In embodiments, the essentially-dried or partially-dried microfibrillated cellulose may be pulverized prior mixing with the dispersing liquid in the mixing tank.

In further embodiments, the microfibrillated cellulose compositions may comprise one or more inorganic particulate material. In embodiments of the present invention, one or more of the optional components may form part of the process.

In another embodiment of the foregoing aspect of the present invention, the method further comprising a hydrocyclone following the rotor-stator apparatus, wherein the hydrocyclone comprises an inlet, a first hydrocyclone outlet, and a second hydrocyclone outlet; wherein the hydrocyclone separates the substantially homogenous suspension into (i) a sheared fine particle stream, preferably with an FLT index greater than 25% of the target value and a Malvern d₅₀ of less than 160 µm and (ii) an under-sheared coarse particle stream, preferably having a Malvern d₅₀ at least 20% larger than the Malvern d₅₀ of the sheared fine particle stream; pumping the under-sheared coarse particle stream from the first hydrocyclone outlet to a second inlet of the mixing apparatus to permit recirculation and remixing of the under-sheared coarse particle stream with the flowable slurry in the mixing tank; flowing the fine particle stream from the second hydrocyclone outlet to an inlet of the second stage high-shear apparatus, selected from a rotor-rotor apparatus, a second high-shear rotor-stator apparatus, a colloid mill, an ultrafine grinding apparatus, or a refiner, wherein the rotor-rotor apparatus comprises counter-rotating rings, for subjecting the substantially homogenous suspension to additional high-shear processing.

In another embodiment of the foregoing aspect and embodiments of the present invention, the composition of microfibrillated cellulose further comprises one or more inorganic particulate material.

In another aspect of the present invention, there is provided a method for the re-dispersion of an essentially-dried or partially-dried and, optionally, pulverized, composition comprising microfibrillated cellulose and, optionally, one or more inorganic particulate material, the method comprising the steps of:
(a) flowing a liquid medium comprising microfibrillated cellulose and, optionally, one or more inorganic particulate material obtained from essentially-dried or partially-dried microfibrillated cellulose and, optionally, one or more inorganic particulate material, to a moderate-shear mixing apparatus comprising a shear-head impeller to form a liquid slurry comprising microfibrillated cellulose and, optionally, one or more inorganic particulate material;
(b) flowing the liquid slurry to a first stage high-shear rotor-stator apparatus, wherein the liquid slurry is subjected to high-shear mixing to form a substantially homogenous suspension;
(c) flowing the substantially homogeneous suspension to a second stage high-shear apparatus selected from a rotor-rotor apparatus, a second stage high-shear rotor-stator apparatus, a colloid mill, an ultrafine grinding apparatus, or a refiner, wherein the rotor-rotor apparatus comprises counter-rotating rings, for subjecting the substantially homogenous suspension to high-shear processing to produce a uniform re-dispersed suspension of microfibrillated cellulose and, optionally, one or more inorganic particulate material; wherein the tensile properties of the microfibrillated cellulose are comparable to the tensile properties of a comparable never-dried suspension of microfibrillated cellulose and, optionally, one or more inorganic particulate material; and
(d) collecting the re-dispersed suspension of microfibrillated cellulose and, optionally one or more inorganic particulate material, in a suitable holding vessel for further end-use applications.

Another embodiment of the foregoing aspect and embodiments of the present invention further comprises the following step. The method of the foregoing aspect of the present invention, wherein the substantially homogeneous suspension is flowed to a hydrocyclone, wherein the substantially homogenous suspension is separated into an undersheared coarse particle stream and a sheared fine particle stream, wherein the undersheared coarse particle stream is recirculated to the moderate shear mixing apparatus and the sheared fine particle stream is flowed to the second high-shear rotor-stator apparatus, a colloid mill, an ultrafine grinding apparatus, or a refiner.

In a further embodiment of the forgoing aspects and embodiments of the present invention the composition of microfibrillated cellulose further comprises one or more inorganic particulate material.

In another aspect of the present invention, there is provided a transportable system (1) for re-dispersing an essentially-dried or partially-dried and, optionally, pulverized composition comprising microfibrillated cellulose and, optionally, one or more inorganic particulate material in a liquid medium to form a liquid composition, comprising:

a mixing tank (20) comprising a mixing apparatus (21) comprising a shear-head impeller (22); wherein the mixing tank (20) comprises a first mixing tank inlet (24) for reception of a liquid slurry of microfibrillated cellulose and, optionally, one or more inorganic particulate material and a mixing tank outlet (26) comprising a pump (27); a first stage high-shear rotor-stator apparatus (30) comprising a rotor-stator inlet (31) connected to the mixing tank outlet (26) and a rotor-stator outlet (32); a second stage high-shear apparatus selected from a rotor-rotor apparatus, a Trigonal® mill, a colloid mill, an ultra-fine grinding apparatus or a refiner; wherein the second stage high-shear apparatus comprises a second stage high-shear inlet (52) connected to the first stage high-shear rotor-stator outlet and an outlet (53); and a storage tank (60) comprising a storage tank inlet (61) connected to the rotor-rotor outlet (53).

In another embodiment of the foregoing aspect of the present invention, the system further comprises a hydrocyclone (40) comprising a hydrocyclone inlet (41), a first hydrocyclone outlet (42), and a second hydrocyclone outlet (43); wherein the hydrocyclone inlet (41) is connected to the rotor-stator outlet (32) of the rotor-stator apparatus; wherein the hydrocyclone separates the slurry of microfibrillated cellulose and, optionally, one or more inorganic particulate material into a sheared fine particle stream and an under-sheared coarse particle stream, wherein the first hydrocyclone outlet (42) is connected to a second inlet (25) of the mixing tank (20) for returning the under-sheared coarse particle stream to the mixing tank (20); wherein the fine particle stream is flowed via the second hydrocyclone outlet (43) to the second stage high-shear inlet (52).

In a further embodiment of the foregoing aspect and embodiments of the present invention, the essentially-dried or partially-dried and, optionally, pulverized composition comprising microfibrillated cellulose further comprises one or more inorganic particulate material.

In further embodiments of the foregoing method aspects and system aspects of the present invention, the essentially-dried or partially-dried composition comprising microfibrillated cellulose and, optionally, one or more inorganic particulate material is pulverized.

In further embodiments of the foregoing method and system aspects of the present invention, the method is a continuous process, semi-continuous process or batch process.

In further embodiments of the foregoing method and system aspects of the present invention, the dispersing liquid is water.

In further embodiments of the foregoing method and system aspects of the present invention, the liquid composition of microfibrillated cellulose is about 0.5 wt% to about 5 wt% fibre solids, or about 0.5 wt% to about 2.5 wt% fibre solids, or about 0.75 wt% fibre solids, about 1 wt% fibre solids, about 1.25 wt% fibre solids, about 1.5 wt% fibre solids, about 1.75 wt% fibre solids, about 2 wt% fibre solids, about 2.5 wt% fibre solids, about 3 wt% fibre solids, about 4 wt%, fibre solids, or about 5 wt% fibre solids. The foregoing embodiments relate to compositions comprising microcellulose and alternative compositions comprising microfibrillated cellulose and one or more inorganic particulate material.

In further embodiments of the foregoing method and system aspects of the present invention, the microfibrillated cellulose may be prepared from a chemical pulp, or a chemithermomechanical pulp, or a mechanical pulp, or a recycled pulp, or a paper broke pulp, or a papermill waste stream, or waste from a papermill, or a combination thereof.

In further embodiments of the foregoing method and system aspects of the present invention, the one or more inorganic particulate material comprises an alkaline earth metal carbonate or sulphate, a hydrous kandite clay, an anhydrous (calcined) kandite clay, talc, mica, perlite or diatomaceous earth, or combinations thereof; or may comprise may comprise calcium carbonate, magnesium carbonate, dolomite, gypsum, kaolin, halloysite, ball clay, metakaolin, fully calcined kaolin, or a combinations thereof.

In other embodiments of the foregoing method and system aspects of the present invention, the one or more inorganic particulate material comprises calcium carbonate.

In other embodiments of the foregoing method and system aspects of the present invention, the one or more inorganic particulate matter comprises kaolin.

In yet other embodiments of the foregoing method and system aspects of the present invention, the one or more inorganic particulate matter comprises kaolin and calcium carbonate. In still other embodiments of the foregoing method and system aspects of the present invention, the calcium carbonate is precipitated calcium carbonate, ground calcium carbonate or a combination thereof; or the calcium carbonate comprises a calcite, aragonite or vaterite structure; or is in a scalenohedral or rhombohedral crystal form.

In other embodiments of the foregoing method and system aspects of the present invention, the kaolin is hyperplaty kaolin.

In other embodiments of the foregoing method and system aspects of the present invention, the inorganic particulate material, for example calcium carbonate and/or kaolin may comprise at least about 50 wt% of the calcium carbonate has an equivalent spherical diameter of less than about 2 µm; or at least about 50 wt% of the kaolin has an equivalent spherical diameter of less than about 2 µm, respectively.

In yet other embodiments of the foregoing method and system aspects of the present invention, the end-use comprises a method of making paper or coating paper, paints, coatings, construction materials, ceiling tiles, material composites, barrier coatings.

In still other embodiments of the foregoing method and system aspects of the present invention, the first stage high-shear rotor-stator apparatus is selected from a Trigonal® mill, a colloid mill, an ultrafine grinding apparatus or a refiner.

In further embodiments of the foregoing method and system aspects of the present invention, the second stage high-shear rotor-stator apparatus is selected from a rotor-rotor apparatus, a Trigonal® mill, a colloid mill, an ultrafine grinding apparatus or a refiner.

### BRIEF DESCRIPTION OF THE DRAWINGS

FIGS. 1A-1B is a schematic of a transportable equipment apparatus and process flow diagram for re-dispersion of microfibrillated cellulose and, optionally, one or more inorganic particulate material, and optional additives. The schematic shown in FIG. 1A does not include a feed hopper. The schematic shown in FIG. 1B includes a feed hopper.

FIGS. 2A-2B is a schematic of a transportable equipment apparatus and process flow diagram for re-dispersion of microfibrillated cellulose and, optionally, one or more inorganic particulate material, and optional additive, wherein the process or system further comprises a hydrocyclone apparatus. The schematic shown in FIG. 2A does not include a feed hopper. The schematic shown in FIG. 2B includes a feed hopper.

FIG. 3 is a plot of the cumulative particle size distribution via a vibratory sieve technique.

FIG. 4 is a plot of the tensile strength (FLT) results of the Example 4: Control Trial 1. The operating conditions were 3.5% total solids, 50 percentage of pulp (POP), 12 m³/h flow rate, 100% speed BVG Shear-Master, 100% speed on Cowles-blade mixer.

FIG. 5 is a plot of tensile strength (FLT) results of Example 5: Control Trial 2 using a 12″ Sprout Refine. The operating conditions were 0.1 J/m intensity, 20 kWh/DMT of MFC NET Specific energy input per pass, 1320 RPM, 1.111 km/rev cutting-edge length. Total solids was 9% and POP was 50%.

FIG. 6 is a plot of the tensile strength (FLT) results of the Example 6: Control Trial 3 using a Trigonal® SM180. The operating conditions were 5400 RPM, 0.1 mm gap-setting and reduction tool was W3 F.S. GL. The total solids was 9% and POP was 50%.

FIG. 7 is a plot of tensile strength (FLT) results of Example 7: Control Trial 4 using an Atrex® CD650. The operating conditions were: 55 kg/min, 2000 RPM and total solids was varied as shown in the graph legend. Standard 6-ring counter-rotating design developed by Megatrex was used.

FIG. 8 is a plot of tensile strength (FLT) for continuous operation of the Atrex® CD650 rotor-rotor high-shear apparatus. The operating conditions were 2000 RPM, 55 kg/min and 9.7% total solids (average measured). The slurry was cascaded from a feed vessel through the Atrex® and into a buffer tank. For the second pass, the contents of the buffer tank were transferred into the feed vessel and the process repeated

FIG. 9A is a drawing depicting using 6-ring and FIG. 9B depicts 8-ring embodiments of the Atrex® counter rotating rotor-rotor rings.

FIG. 10 is a plot of the tensile strength (FLT) results obtained using FLT results for the Atrex® 8-ring design (first pass) with pre-wetting using a Silverson® batch mixer. The operating conditions were - 55 kg/min, 2000 RPM and 9.7% total solids (average measured). The POP was 50%.

FIG. 11 is a plot of tensile strength (FLT) results for the Atrex® 8-ring design (first and second pass) with pre-wetting using a Silverson® batch mixer. Results are shown against cumulative energy input (gross).

FIG. 12 is a plot of tensile strength (FLT) results of the inventive system and process (single pass) at two different solids concentrations.

FIG. 13 is a graph depicting how the chosen Vortex-Finder to Spigot Ratio impacts the D50 on the 1″ hydrocyclone at 4 bar pressure at 1.7% total solids.

FIG. 14 is a graph depicting how the chosen Vortex-Finder to Spigot Ratio impacts the <300 µm fraction on the 1″ hydrocyclone at 4 bar pressure at 1.7% total solids.

FIG. 15, is graph depicting how the chosen Vortex-Finder to Spigot Ratio impacts the Fibrillation % (with constant fines B) as measured by the Valmet Fibre-analyser on the 1″ hydrocyclone at 4 bar pressure and 1.7% total solids.

FIG. 16 is a graph depicting how the chosen Vortex-Finder to Spigot Ratio impacts the total solids on the 1″ hydrocyclone at 4 bar pressure and 1.7% total solids.

FIG. 17 is a graph depicting how the Vortex-Finder to Spigot Ratio affects total solids percentage, on the 2″ hydrocyclone at 2 bar pressure and 9% total solids.

FIG. 18 is a graph depicting how the Vortex-Finder to Spigot Ratio affects the Malvern D50, on the 2″ hydrocyclone at 2 bar pressure and 9% total solids.

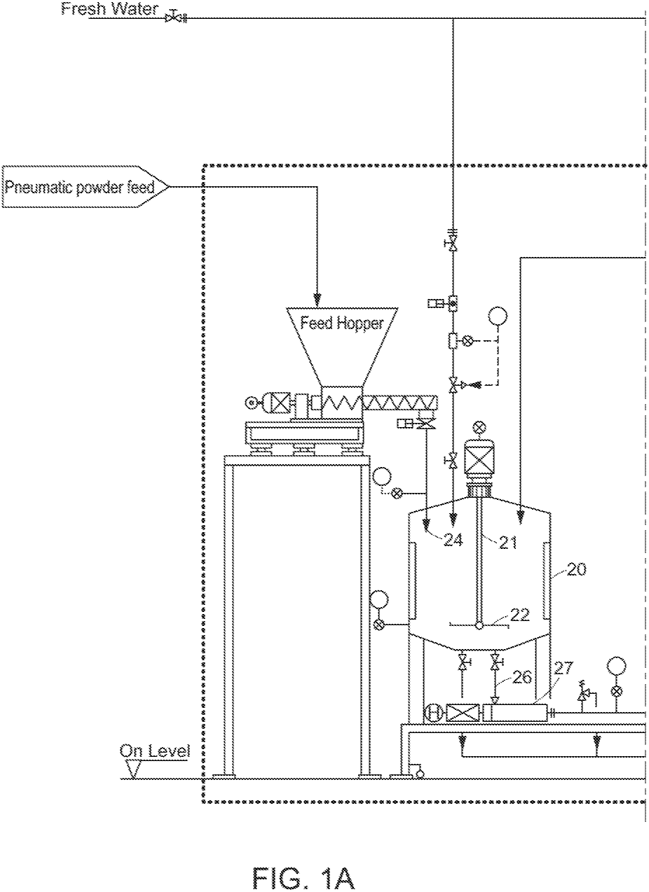

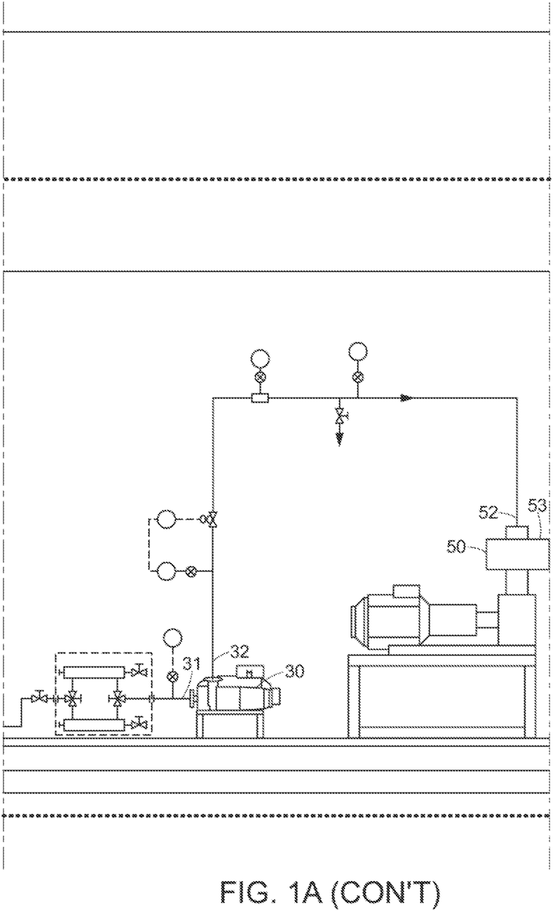

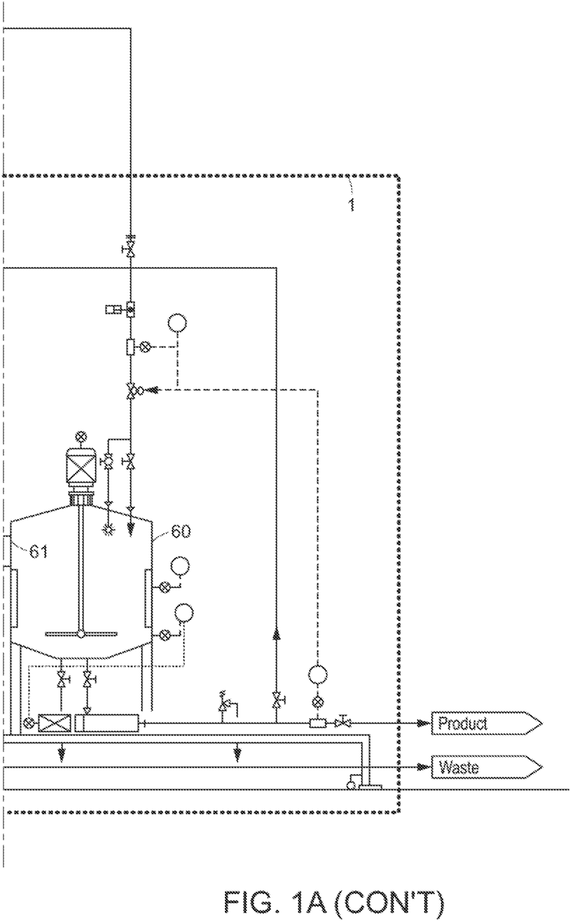

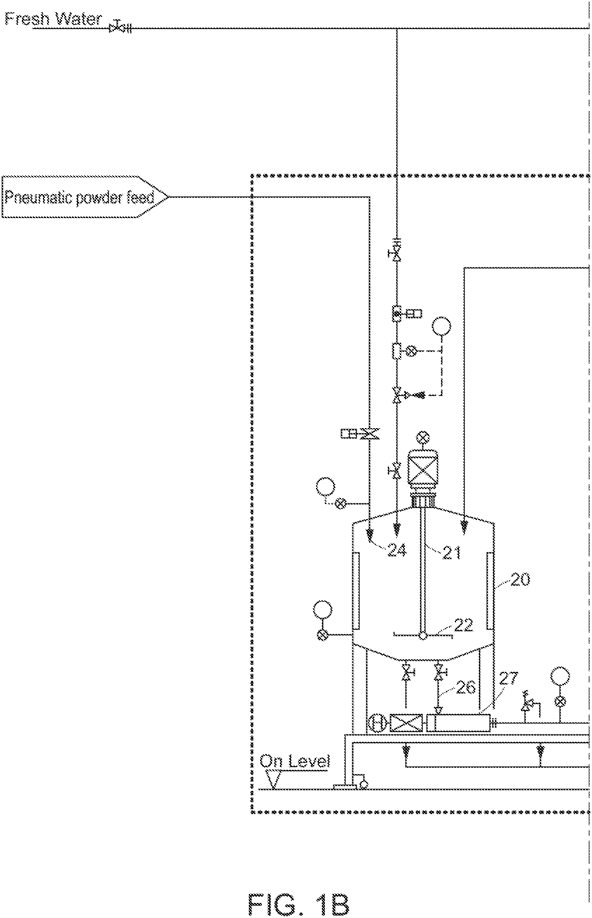

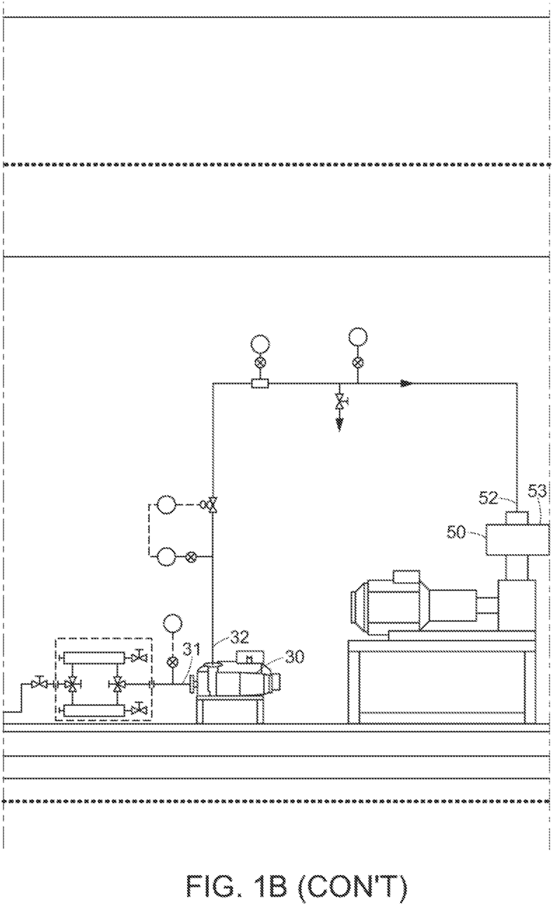

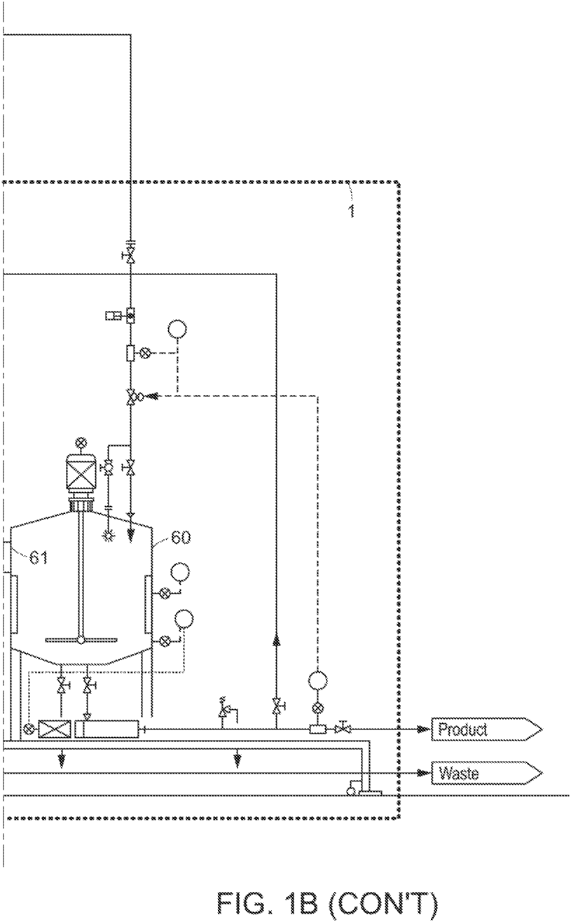

### DETAILED DESCRIPTION OF THE INVENTION

### Certain Definitions

The titles, headings and subheadings provided herein should not be interpreted as limiting the various aspects of the disclosure. Accordingly, the terms defined below are more fully defined by reference to the specification in its entirety. All references cited herein are incorporated by reference in their entirety.

Unless otherwise defined, scientific and technical terms used herein shall have the meanings that are commonly understood by those of ordinary skill in the art. Further, unless otherwise required by context, singular terms shall include pluralities and plural terms shall include the singular.

In this application, the use of “or” means “and/or” unless stated otherwise. In the context of a multiple dependent claim, the use of “or” refers back to more than one preceding independent or dependent claim in the alternative only. The use of the word “a” or “an” when used in conjunction with the term “comprising” may mean “one,” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.”

Throughout this application, the term “about” is used to indicate that a value includes the inherent variation of error for the quantifying device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 1, 2, 3, 4, 5, 10, 15, 20, 30, 40, 50, 100, etc. The term “at least one” or “one or more” may extend up to 100 or 1000 or more depending on the term to which it is attached. In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the terms “comprising” (and any form of comprising, such as “comprise”, “comprises”, and “comprised”), “having” (and any form of having, such as “have” and “has”), “including” (and any form of including, such as “includes” and “include”), or “containing” (and any form of containing, such as “contains” and “contain”), are inclusive or open-ended and do not exclude additional, un-recited elements or method steps. Additionally, a term that is used in conjunction with the term “comprising” is also understood to be able to be used in conjunction with the term “consisting of’ or “consisting essentially of.

By “deagglomerate,” “de-agglomerate,” ‘de-agglomeration, and the like, is meant a process of breaking up agglomerates.

By “essentially-dried” or “dry” is meant that the water content of an aqueous composition comprising microfibrillated cellulose, and, optionally, one or more inorganic particulate material is reduced by at least about 95% by weight water.

By “partially-dried” or “partially-dry” is meant that the water content of the aqueous composition comprising microfibrillated cellulose is reduced by an amount less than 95% by weight. In certain embodiments, “partially-dried” or “partially-dry” means that the water content of the aqueous composition comprising microfibrillated cellulose is reduced by at least 50% by weight, for example, by at least 75% by weight, or by at least 90% by weight. In an embodiment, the aqueous suspension is treated to remove at least a portion or substantially all of the water to form a partially-dried or essentially-dried product. For example, at least about 10% by volume of water in the aqueous suspension may be removed from the aqueous suspension, for example, at least about 20% by volume, or at least about 30% by volume, or least about 40% by volume, or at least about 50% by volume, or at least about 60% by volume, or at least about 70% by volume or at least about 80% by volume or at least about 90% by volume, or at least 95% by volume, or at least about 1 00% by volume of water in the aqueous suspension may be removed. Any suitable technique can be used to remove water from the aqueous suspension including, for example, by gravity or vacuum-assisted drainage, with or without pressing, or by evaporation, or by filtration, or by a combination of these techniques. The partially-dried or essentially-dried composition will comprise microfibrillated cellulose and, optionally one or more inorganic particulate material and any other optional additives that may have been added to the aqueous suspension prior to drying. The partially-dried or essentially-dried product may be stored or packaged for sale. The partially-dried or essentially-dried product may be optionally re-hydrated and incorporated in papermaking compositions and other paper products, as described herein.

Various methods are known to the skilled person for preparing partially-dried or essentially-dried compositions comprising microfibrillated cellulose and, optionally, one or more inorganic particulate material. For example, methods disclosed in the prior art and which are incorporated herein by reference in their entirety are disclosed in U.S. Pat. Nos. 10,435,482 and 11,001,644.

The process of U.S. Pat. No. 10,435,482, is described as a method of improving the physical and/or mechanical properties of re-dispersed dried or partially-dried microfibrillated cellulose, the method comprising: (a) providing an aqueous composition of microfibrillated cellulose; (b) dewatering the aqueous composition by one or more of: i. dewatering by belt press, ii. a high pressure automated belt press, iii. centrifuge, iv. tube press, v. screw press, and vi. rotary press; to produce a dewatered microfibrillated cellulose composition; (c) drying the dewatered microfibrillated cellulose composition by one or more of: i. a fluidized bed dryer, ii. microwave and/or radio frequency dryer, iii. a hot air swept mill or dryer, a cell mill or a multirotor cell mill, and iv. freeze drying; to produce a dried or partially-dried microfibrillated cellulose composition; and (d) re-dispersing the dried or at least partially dried microfibrillated cellulose in a liquid medium; wherein the microfibrillated cellulose has a tensile index and/or viscosity which is at least 50% of the tensile index and/or viscosity of the aqueous composition of microfibrillated cellulose prior to drying at a comparable concentration and a fibre steepness of from 20 to 50.

The process of U.S. Pat. No. 11,001,644 is described as a method of improving the physical and/or mechanical properties of redispersed dried or partially dried microfibrillated cellulose, the method comprising: (a) providing an aqueous composition of microfibrillated cellulose, wherein the microfibrillated cellulose is obtained from a recycled pulp, or a papermill broke, or a papermill waste stream, or waste from a papermill; (b) dewatering the aqueous composition by one or more of: dewatering by belt press, a high pressure automated belt press, iii. centrifuge, tube press, screw press, and rotary press to produce a dewatered microfibrillated cellulose composition; (c) drying the dewatered microfibrillated cellulose composition by one or more of: i. a fluidized bed dryer, ii. microwave and/or radio frequency dryer, a hot air swept mill or dryer, a cell mill or a multirotor cell mill, and freeze drying to produce a dried or partially dried microfibrillated cellulose composition; and (d) re-dispersing the dried or at least partially dried microfibrillated cellulose in a liquid medium; wherein the microfibrillated cellulose has a tensile index and/or viscosity which is at least 50% of the tensile index and/or viscosity of the aqueous composition of microfibrillated cellulose prior to drying at a comparable concentration and a fibre steepness of from 20 to 50. Alternative processes for re-dispersing partially-dried or essentially-dried microfibrillated cellulose are disclosed in U.S. Pat. Publication No. 20200263358A1, which method is incorporated herein by reference in its entirety.

In U.S. Pat. Publication No. 20200263358 there is provided a method for re-dispersing dewatered, partially dried or essentially dried microfibrillated cellulose, the method comprising the steps of: (a) adding a quantity of a suitable dispersing liquid to a tank having at least a first and a second inlet and an outlet, wherein the tank further comprises a mixer and a pump attached to the outlet; (b) adding a quantity of dewatered, partially dried or essentially dried microfibrillated cellulose to the tank through the first inlet in sufficient quantity to yield a liquid composition of microfibrillated cellulose at a desired solids concentration of 0.5 to 5% fibre solids; (c) mixing the dispersing liquid and the dewatered, partially dried or essentially dried microfibrillated cellulose in the tank with the mixer to partially de-agglomerate and re-disperse the microfibrillated cellulose to form a flowable slurry; (d) pumping the flowable slurry with the pump to an inlet of a flow cell, wherein the flow cell comprises a recirculation loop and one or more sonication probe in series and at least a first and a second outlet, wherein the second outlet of the flow cell is connected to the second inlet of the tank, thereby providing for a continuous recirculation loop providing for the continuous application of ultrasonic energy to the slurry for a desired time period and/or total energy, wherein the flow cell comprises an adjustable valve at the second outlet to create back pressure of the recirculated slurry, further wherein the liquid composition comprising microfibrillated cellulose of step (c) is continuously recirculated through the recirculation loop at an operating pressure of 0 to 4 bar and at a temperature of 20° C. to 50° C.; (e) applying an ultrasonic energy input to the slurry of 200 to 10,000 kWh/t continuously by the sonication probe at a frequency range of 19 to 100 kHz and at an amplitude of up to 60%, up to 100% or up to 200% to the physical limitations of the sonicator used for 1 to 120 minutes; (f) collecting the re-dispersed suspension comprising microfibrillated cellulose with enhanced tensile strength and/or viscosity properties from the first outlet of the flow cell in a suitable holding vessel.

The terms “re-dispersion,” “re-dispersing,” and “re-dispersed” refer to the suspension of dried and, optionally, pulverized, micro-fibrillated cellulose and, optionally, one or more inorganic particulate material in an aqueous medium to achieve a comparable tensile strength property as before drying had occurred. This is characterised by the “tensile index” or “FLT index.”

As used herein, “FLT Index” is a tensile strength measurement performed in accordance with the procedures of Example 1.

The FLT index is a tensile test developed to assess the quality of microfibrillated cellulose and re-dispersed microfibrillated cellulose. The Percentage of Pulp (“POP”) of the test material is adjusted to 20% by adding whichever inorganic particulate was used in the production of the microfibrillated cellulose/ inorganic material composite (in the case of inorganic particulate free microfibrillated cellulose then 60 wt%<2 µm GCC calcium carbonate is used). A 220 gsm sheet is formed from this material using a bespoke Buchner filtration apparatus. The resultant sheet is conditioned and its tensile strength measured using an industry standard tensile tester.

As used herein, the term “include” and its grammatical variants are intended to be non-limiting, such that recitation of items in a list is not to the exclusion of other like items that can be substituted or added to the listed items.

As used herein, “mechanical properties” of the essentially-dried or partially-dried MFC compositions include one or more of the following: Tensile Strength, Tensile Elongation, Tensile Index, Burst Strength, Tear Strength, Tear Index, Scott Bond, Breaking Energy and Breaking Elongation.

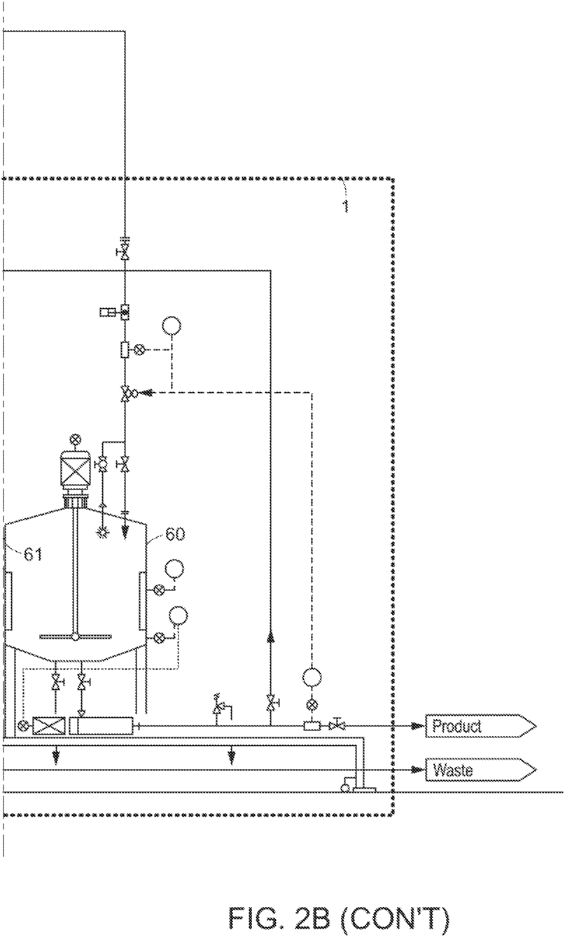

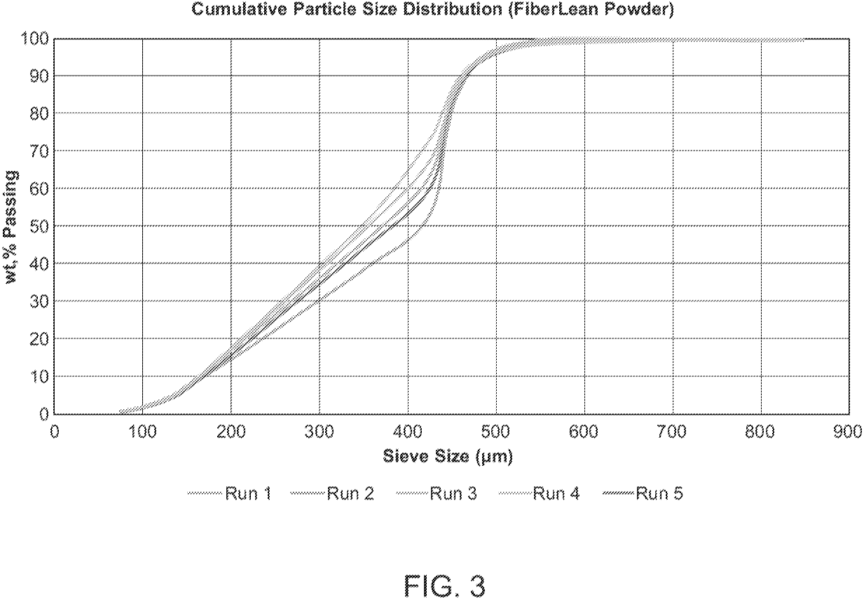

As used herein, the term “pulverize,” “pulverized,” and “pulverization” mean the mechanical disintegration of MFC press-cake into a powder with the cumulative size distribution, measured using a vibratory machine with sieves stacked in descending order of particle size fractions shown in FIG. 3.

By linear interpolation of raw data, the following characteristics of the curve can be used as shown below in Table 1.

TABLE 1

| Parameter | Run 1 | Run 2 | Run 3 | Run 4 | Run 5 |
|---|---|---|---|---|---|
| d₉₀ | 484.2 | 489.0 | 484.3 | 480.5 | 487.6 |
| d₅₀ | 369.0 | 410.0 | 355.4 | 349.1 | 378.1 |
| d₁₀ | 161.6 | 169.0 | 160.7 | 162.0 | 167.7 |

As used herein, a mixer with a shear head impeller imparts “moderate shear” to the essentially-dried or partially-dried, and optionally, pulverized, composition comprising microfibrillated cellulose or microfibrillated cellulose and one or more inorganic particulate material composition. An example of a moderate shear mixer useful in the present invention is a Cowles-blade (radial-flow impeller) inside a holding vessel, where, for example, tip speeds less than 20 m/s are encountered with an impeller (D) to tank (T) diameter less than 0.5, i.e., D/T<0.5. Other exemplary mixers include various propeller mixers, dual shaft and triple shaft mixers, (e.g., Ross mixers), dispersers having blade mixers, Silverson® mixers, Myers mixers, PVC mixers, and other similar generic mixers as known by the skilled person.

As used herein a rotor-stator mixer, for example, a Trigonal® mixer (Siefer-Trigonal machine), or more generally a colloid mill, or a refiner, which impart relatively higher shear-rates, depending on required shear-levels and physical limits of the design compared to a shear head mixer imparting moderate shear. Another apparatus includes a Cavitron® rotor-stator mixer supplied by Hagen & Funke GmbH. Sprockhövel, Germany.

As used herein, a “rotor-rotor mixer” produces high and focused shear with high viscosity slurries compared to conventional mixers. Rotor-rotor mixers have two counter-rotating mixing elements (rotors) which are capable of imparting high shear forces. Due to the geometry of the mixer, the liquid slurry is forced through a zone of high shear forces formed by the rotors. An exemplary rotor-rotor mixer is an Atrex® mixer supplied by Megatrex Oy, Lempäälä, Finland. Alternative apparatus include an ultra-fine friction grinder (Supermasscolloider® available from Masuko Sangyo Co. Ltd., Japan. An example of an Atrex® mixer is a rotor-rotor dispergator, model G30, diameter 500 mm, 6 rotor peripheries, rotation speed applied 1500 rpm (counter-rotating rotors). The preferred gap width is less than 10 mm and preferably less than 5 mm. So-called rotor-rotor dispergators, where a series of frequently repeated impacts to the dispersion are caused by blades of several rotors that rotate in opposite directions. Atrex® dispergator is an example of such a dispergator. The adjacent rotors rotated in opposite directions at 1500 rpm.

As used herein, an “under-sheared coarse particle stream” comprises particle sizes at least 20% greater than the overflow/fine stream d₅o(µm).

### Fibrous Substrate Comprising Cellulose

The fibrous substrate comprising cellulose (variously referred to herein as “fibrous substrate comprising cellulose,” “cellulose fibres,” “fibrous cellulose feedstock,” “cellulose feedstock” and “cellulose-containing fibres (or fibrous,” etc.) may be derived from virgin or recycled pulp.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. In the context of “substantially homogenous suspension” the suspension is understood to have minimal aggregates.

As used herein, “viscosity” is measured in accordance with the procedures of Example 2.

Unless otherwise stated, particle size properties referred to herein for the inorganic particulate materials are as measured in a well-known manner by sedimentation of the particulate material in a fully dispersed condition in an aqueous medium using a Sedigraph 5100 machine as supplied by Micromeritics Instruments Corporation, Norcross, Ga., USA (telephone: + 1 770 662 3620; web-site: www.micromeritics.com), referred to herein as a “Micromeritics Sedigraph 5100 unit”. Such a machine provides measurements and a plot of the cumulative percentage by weight of particles having a size, referred to in the art as the “equivalent spherical diameter” (e.s.d), less than given e.s.d values. The mean particle size d₅₀ is the value determined in this way of the particle e.s.d at which there are 50% by weight of the particles which have an equivalent spherical diameter less than that d₅₀ value.

Alternatively, where stated, the particle size properties referred to herein for the inorganic particulate materials are as measured by the well-known conventional method employed in the art of laser light scattering, using a Malvern Mastersizer S machine as supplied by Malvern Instruments Ltd (or by other methods which give essentially the same result). In the laser light scattering technique, the size of particles in powders, suspensions and emulsions may be measured using the diffraction of a laser beam, based on an application of Mie theory. Such a machine provides measurements and a plot of the cumulative percentage by volume of particles having a size, referred to in the art as the “equivalent spherical diameter” (e.s.d), less than given e.s.d values. The mean particle size d₅₀ is the value determined in this way of the particle e.s.d at which there are 50% by volume of the particles which have an equivalent spherical diameter less than that d₅₀ value.

As used herein, the phrase “integer from X to Y” means any integer that includes the endpoints. For example, the phrase “integer from 1 to 5” means 1, 2, 3, 4, or 5.

### Microfibrillated Cellulose

Microfibrillated cellulose (“MFC”), although well-known and described in the art, for purposes of the presently disclosed and/or claimed inventive concept(s), is defined as cellulose consisting of microfibrils in the form of either isolated cellulose microfibrils and/or microfibril bundles of cellulose, both of which are derived from a cellulose raw material. Thus, microfibrillated cellulose is understood to comprise partly or totally fibrillated cellulose or lignocellulose fibers, which may be achieved by a variety of processes known in the art.

As used herein, “microfibrillated cellulose” can be used interchangeably with “microfibrillar cellulose,” “nanofibrillated cellulose,” “nanocellulose,” “nanofibril cellulose,” “nanofibers of cellulose,” “nanoscale fibrillated cellulose,” “microfibrils of cellulose,” and/or simply as “MFC.” Additionally, as used herein, the terms listed above that are interchangeable with “microfibrillated cellulose” may refer to cellulose that has been completely microfibrillated or cellulose that has been substantially microfibrillated but still contains an amount of non-microfibrillated cellulose at levels that do not interfere with the benefits of the microfibrillated cellulose as described and/or claimed herein.

By “microfibrillating” is meant a process in which microfibrils of cellulose are liberated or partially liberated as individual species or as small aggregates as compared to the fibres of the pre-microfibrillated pulp. Typical cellulose fibres (i.e., pre-microfibrillated pulp) suitable for use in papermaking include larger aggregates of hundreds or thousands of individual cellulose fibrils.

Microfibrillated cellulose comprises cellulose, which is a naturally occurring polymer comprising repeated glucose units. The term “microfibrillated cellulose”, also denoted MFC, as used in this specification includes microfibrillated/microfibrillar cellulose and nanofibrillated/nanofibrillar cellulose (NFC), which materials are also called nanocellulose.

Microfibrillated cellulose is prepared by stripping away the outer layers of cellulose fibers that may have been exposed through mechanical shearing, with or without prior enzymatic or chemical treatment. There are numerous methods of preparing microfibrillated cellulose that are known in the art.

In a non-limiting example, the term microfibrillated cellulose is used to describe fibrillated cellulose comprising nanoscale cellulose particle fibers or fibrils frequently having at least one dimension less than 100 nm. When liberated from cellulose fibres, fibrils typically have a diameter less than 100 nm. The actual diameter of cellulose fibrils depends on the source and the manufacturing methods.

The particle size distribution and/or aspect ratio (length/width) of the cellulose microfibrils attached to the fibrillated cellulose fiber or as a liberated microfibril depends on the source and the manufacturing methods employed in the microfibrillation process.

In a non-limiting example, the aspect ratio of microfibrils is typically high and the length of individual microfibrils may be more than one micrometer and the diameter may be within a range of about 5 to 60 nm with a number-average diameter typically less than 20 nm. The diameter of microfibril bundles may be larger than 1 micron, however, it is usually less than one.

In a non-limiting example, the smallest fibril is conventionally referred to as an elementary fibril, which generally as a diameter of approximately 2-4 nm. It is also common for elementary fibrils to aggregate, which may also be considered as microfibrils.

In a non-limiting example, the microfibrillated cellulose may at least partially comprise nanocellulose. The nanocellulose may comprise mainly nano-sized fibrils having a diameter that is less than 100 nm and a length that may be in the micron-range or lower. The smallest microfibrils are similar to the so-called elemental fibrils, the diameter of which is typically 2 to 4 nm. Of course, the dimensions and structures of microfibrils and microfibril bundles depend on the raw materials used in addition to the methods of producing the microfibrillated cellulose. Nonetheless, it is expected that a person of ordinary skill in the art would understand the meaning of “microfibrillated cellulose” in the context of the presently disclosed and/or claimed inventive concept(s).

Depending on the source of the cellulose fibers and the manufacturing process employed to microfibrillate the cellulose fibres, the length of the fibrils can vary, frequently from about 1 to greater than 10 micrometers.

A coarse MFC grade might contain a substantial fraction of fibrillated fibers, i.e. protruding fibrils from the tracheid (cellulose fiber), and with a certain amount of fibrils liberated from the tracheid (cellulose fiber).

In certain embodiments, the microfibrillated cellulose has a d₅₀ ranging from about 5 µm to about 500 µm, as measured by laser light scattering. In certain embodiments, the microfibrillated cellulose has a d₅₀ of equal to or less than about 400 µm, for example equal to or less than about 300 µm, or equal to or less than about 200 µm, or equal to or less than about 150 µm, or equal to or less than about 125 µm, or equal to or less than about 100 µm, or equal to or less than about 90 µm, or equal to or less than about 80 µm, or equal to or less than about 70 µm, or equal to or less than about 60 µm, or equal to or less than about 50 µm, or equal to or less than about 40 µm, or equal to or less than about 30 µm, or equal to or less than about 20 µm, or equal to or less than about 10 µm.

In certain embodiments, the microfibrillated cellulose has a modal fibre particle size ranging from about 0.1-500 µm.

In certain embodiments, the microfibrillated cellulose has a modal fibre particle size of at least about 0.5 µm, for example at least about 10 µm, or at least about 50 µm, or at least about 100 µm, or at least about 150 µm, or at least about 200 µm, or at least about 300 µm, or at least about 400 µm

In an embodiment, the microfibrillated cellulose may also be prepared from recycled pulp or a papermill broke and/or industrial waste, or a paper streams rich in mineral fillers and cellulosic materials from a papermill.

The microfibrillated cellulose may, for example, be treated prior to dewatering and/or drying. For example, one or more additives as specified below (e.g. salt, sugar, glycol, urea, glycol, carboxymethyl cellulose, guar gum, or a combination thereof as specified below) may be added to the microfibrillated cellulose. For example, one or more oligomers (e.g. with or without the additives specified above) may be added to the microfibrillated cellulose. For example, one or more inorganic particulate materials may be added to the microfibrillated cellulose to improve dispersibility (e.g. talc or minerals having a hydrophobic surface-treatment such as a stearic acid surface-treatment (e.g. stearic acid treated calcium carbonate). The additives may, for example, be suspended in low dielectric solvents. The microfibrillated cellulose may, for example, be in an emulsion, for example an oil/water emulsion, prior to dewatering and/or drying. The microfibrillated cellulose may, for example, be in a masterbatch composition, for example a polymer masterbatch composition and/or a high solids masterbatch composition, prior to dewatering and/or drying. The microfibrillated cellulose may, for example, be a high solids composition (e.g. solids content equal to or greater than about 60 wt% or equal to or greater than about 70 wt% or equal to or greater than about 80 wt% or equal to or greater than about 90 wt% or equal to or greater than about 95 wt% or equal to or greater than about 98 wt% or equal to or greater than about 99 wt%) prior to dewatering and/or drying. Any combination of one or more of the treatments may additionally or alternatively be applicable to the microfibrillated cellulose after dewatering and drying but prior to or during re-dispersion.

The fibrous substrate comprising cellulose may be added to a grinding vessel fibrous substrate comprising cellulose in a dry state. For example, a dry paper broke may be added directly to the grinder vessel. The aqueous environment in the grinder vessel will then facilitate the formation of a pulp.

Various methods of producing microfibrillated cellulose (“MFC”) are known in the art. Certain methods and compositions comprising microfibrillated cellulose produced by grinding procedures are described in WO 2010/131016. Husband, J. C., Svending, P., Skuse, D. R., Motsi, T., Likitalo, M., Coles, A., FiberLean Technologies Ltd., 2015, “Paper filler composition,” PCT International Application No. WO 2010/131016. Paper products comprising such microfibrillated cellulose have been shown to exhibit excellent paper properties, such as paper burst and tensile strength. The methods described in WO 2010/131016 also enable the production of microfibrillated cellulose economically.

WO 2007/091942 A1 describes a process, in which chemical pulp is first refined, then treated with one or more wood degrading enzymes, and finally homogenized to produce MFC as the final product. The consistency of the pulp is taught to be preferably from 0.4 to 10%. The advantage is said to be avoidance of clogging in the high-pressure fluidizer or homogenizer.

WO 2010/131016 describes a grinding procedure for the production of microfibrillated cellulose with or without inorganic particulate material. Such a grinding procedure is described below. In an embodiment of the process set forth in WO 2010/131016, the contents of which is hereby incorporated by reference in its entirety, the process utilizes mechanical disintegration of cellulose fibres to produce microfibrillated cellulose (“MFC”) cost-effectively and at large scale, without requiring cellulose pre-treatment. An embodiment of the method uses stirred media detritor grinding technology, which disintegrates fibres into MFC by agitating grinding media beads. In this process, a mineral such as calcium carbonate or kaolin is added as a grinding aid, greatly reducing the energy required. Husband, J. C., Svending, P., Skuse, D. R., Motsi, T., Likitalo, M., Coles, A., FiberLean Technologies Ltd., 2015, “Paper filler composition,” U.S. Pat. US9127405B2.

### Preparing the Aqueous Suspension of Microfibrillated Cellulose and Inorganic Particulate Material

In certain embodiments, the composition comprising microfibrillated cellulose is obtainable by a process comprising microfibrillating a fibrous substrate comprising cellulose in the presence of a grinding medium. The process is advantageously conducted in an aqueous environment.

The particulate grinding medium, when present, may be of a natural or a synthetic material. The grinding medium may, for example, comprise balls, beads or pellets of any hard mineral, ceramic or metallic material. Such materials may include, for example, alumina, zirconia, zirconium silicate, aluminum silicate or the mullite-rich material which is produced by calcining kaolinitic clay at a temperature in the range of from about 1300° C. to about 1800° C. For example, in some embodiments a Carbolite® grinding media is preferred. Alternatively, particles of natural sand of a suitable particle size may be used.

The grinding may be carried out in one or more stages. For example, a coarse inorganic particulate material may be ground in the grinder vessel to a predetermined particle size distribution, after which the fibrous material comprising cellulose is added and the grinding continued until the desired level of microfibrillation has been obtained. The coarse inorganic particulate material used in accordance with the first aspect of this invention initially may have a particle size distribution in which less than about 20% by weight of the particles have an equivalent spherical diameter (e.s.d.) of less than 2 µm for example, less than about 15% by weight, or less than about 10% by weight of the particles have an e.s.d. of less than 2 µm. In another embodiment, the coarse inorganic particulate material used in accordance with the first aspect of this invention initially may have a particle size distribution, as measured using a Malvern Insitec or equivalent apparatus, in which less than about 20% by volume of the particles have an e.s.d of less than 2 µm for example, less than about 15% by volume, or less than about 10% by volume of the particles have an e.s.d. of less than 2 µm. In another embodiment, the fibrous material containing cellulose may be ground in the presence of a grinding medium and in the absence of inorganic particulate matter, as described below.

The coarse inorganic particulate material may be wet or dry ground in the absence or presence of a grinding medium. In the case of a wet grinding stage, the coarse inorganic particulate material is preferably ground in an aqueous suspension in the presence of a grinding medium. In such a suspension, the coarse inorganic particulate material may preferably be present in an amount of from about 5% to about 85% by weight of the suspension; more preferably in an amount of from about 20% to about 80% by weight of the suspension. Most preferably, the coarse inorganic particulate material may be present in an amount of about 30% to about 75% by weight of the suspension. As described above, the coarse inorganic particulate material may be ground to a particle size distribution such that at least about 10% by weight of the particles have an e.s.d of less than 2 µm, for example, at least about 20% by weight, or at least about 30% by weight, or at least about 40% by weight, or at least about 50% by weight, or at least about 60% by weight, or at least about 70% by weight, or at least about 80% by weight, or at least about 90% by weight, or at least about 95% by weight, or about 100% by weight of the particles, have an e.s.d of less than 2 µm after which the cellulose pulp is added and the two components are co-ground to microfibrillate the fibres of the cellulose pulp. In another embodiment, the coarse inorganic particulate material is ground to a particle size distribution, as measured using a Malvern Insitec apparatus (or equivalent) such that at least about 10% by volume of the particles have an e.s.d of less than 2 µm, for example, at least about 20% by volume, or at least about 30% by volume or at least about 40% by volume, or at least about 50% by volume, or at least about 60% by volume, or at least about 70% by volume, or at least about 80% by volume, or at least about 90% by volume, or at least about 95% by volume, or about 100% by volume of the particles, have an e.s.d of less than 2 µm after which the cellulose pulp is added and the two components are co-ground to microfibrillate the fibres of the cellulose pulp.

Generally, the type of and particle size of grinding medium to be selected for use in the invention may be dependent on the properties, e.g., the particle size of, and the chemical composition of, the feed suspension of material to be ground. Preferably, the particulate grinding medium comprises particles having an average diameter in the range of from about 0.1 mm to about 6.0 mm and, more preferably, in the range of from about 0.2 mm to about 4.0 mm. The grinding medium (or media) may be present in an amount up to about 70% by volume of the charge. The grinding media may be present in amount of at least about 10% by volume of the charge, for example, at least about 20% by volume of the charge, or at least about 30% by volume of the charge, or at least about 40% by volume of the charge, or at least about 50% by volume of the charge, or at least about 60% by volume of the charge.

Unless otherwise stated, particle size properties of the microfibrillated cellulose materials are as measured by the well-known conventional method employed in the art of laser light scattering, using a Malvern Insitec apparatus (or equivalent), as supplied by Malvern Instruments Ltd (or by other methods which give essentially the same result.

The fibrous substrate comprising cellulose may be in the form of a pulp (i.e., a suspension of cellulose fibres in water), which may be prepared by any suitable chemical or mechanical treatment, or combination thereof.

Details of the procedure used to characterise the particle size distributions of mixtures of inorganic particle material and microfibrillated cellulose using a Malvern Insitec apparatus (or equivalent) are provided below.

The fibrous substrate comprising cellulose may be microfibrillated in the presence of an inorganic particulate material to obtain microfibrillated cellulose having a d₅₀ ranging from about 5 µm to about 500 µm, as measured by laser light scattering. The fibrous substrate comprising cellulose may be microfibrillated in the presence of an inorganic particulate material to obtain microfibrillated cellulose having a d₅₀ of equal to or less than about 400 µm, for example equal to or less than about 300 µm, or equal to or less than about 200 µm, or equal to or less than about 150 µm, or equal to or less than about 125 µm, or equal to or less than about 100 µm, or equal to or less than about 90 µm, or equal to or less than about 80 µm, or equal to or less than about 70 µm, or equal to or less than about 60 µm, or equal to or less than about 50 µm, or equal to or less than about 40 µm, or equal to or less than about 30 µm, or equal to or less than about 20 µm, or equal to or less than about 10 µm.

The fibrous substrate comprising cellulose may be microfibrillated in the presence of an inorganic particulate material to obtain microfibrillated cellulose having a modal fibre particle size ranging from about 0.1-500 µm and a modal inorganic particulate material particle size ranging from 0.25-20 µm. The fibrous substrate comprising cellulose may be microfibrillated in the presence of an inorganic particulate material to obtain microfibrillated cellulose having a modal fibre particle size of at least about 0.5 µm, for example at least about 10 µm, or at least about 50 µm, or at least about 100 µm, or at least about 150 µm, or at least about 200 µm, or at least about 300 µm, or at least about 400 µm.

The fibrous substrate comprising cellulose may be microfibrillated in the presence of an inorganic particulate material to obtain microfibrillated cellulose having a fibre steepness equal to or greater than about 10, as measured by Malvern. Fibre steepness (i.e., the steepness of the particle size distribution of the fibres) is determined by the following formula:

Steepness = 100 × (d₃₀/d₇₀).

The microfibrillated cellulose may have a fibre steepness equal to or less than about 100. The microfibrillated cellulose may have a fibre steepness equal to or less than about 75, or equal to or less than about 50, or equal to or less than about 40, or equal to or less than about 30. The microfibrillated cellulose may have a fibre steepness from about 20 to about 50, or from about 25 to about 40, or from about 25 to about 35, or from about 30 to about 40.

The finer mineral peak can be fitted to the measured data points and subtracted mathematically from the distribution to leave the fibre peak, which can be converted to a cumulative distribution. Similarly, the fibre peak can be subtracted mathematically from the original distribution to leave the mineral peak, which can also be converted to a cumulative distribution. Both these cumulative curves may then be used to calculate the mean particle size (d₅₀) and the steepness of the distribution (d₃₀/d₇₀ × 100). The differential curve may then be used to find the modal particle size for both the mineral and fibre fractions.

### The Inorganic Particulate Material

The inorganic particulate material, when present, may, for example, be an alkaline earth metal carbonate or sulphate, such as calcium carbonate, magnesium carbonate, dolomite, gypsum, a hydrous kandite day such as kaolin, halloysite or ball clay, an anhydrous (calcined) kandite clay such as metakaolin or fully calcined kaolin, talc, mica, perlite or diatomaceous earth, or magnesium hydroxide, or aluminum trihydrate, or combinations thereof.

A preferred inorganic particulate material for use in the method is calcium carbonate. Hereafter, the invention may tend to be discussed in terms of calcium carbonate, and in relation to aspects where the calcium carbonate is processed and/or treated. The invention should not be construed as being limited to such embodiments.

The particulate calcium carbonate used in the present invention may be obtained from a natural source by grinding. Ground calcium carbonate (GCC) is typically obtained by crushing and then grinding a mineral source such as chalk, marble or limestone, which may be followed by a particle size classification step, in order to obtain a product having the desired degree of fineness. Other techniques such as bleaching, flotation and magnetic separation may also be used to obtain a product having the desired degree of fineness and/or color. The particulate solid material may be ground autogenously, i.e. by attrition between the particles of the solid material themselves, or, alternatively, in the presence of a particulate grinding medium comprising particles of a different material from the calcium carbonate to be ground. These processes may be carried out with or without the presence of a dispersant and biocides, which may be added at any stage of the process.

Precipitated calcium carbonate (PCC) may be used as the source of particulate calcium carbonate in the present invention, and may be produced by any of the known methods available in the art. TAPPI Monograph Series No 30, “Paper Coating Pigments”, pages 34-35 describes the three main commercial processes for preparing precipitated calcium carbonate which is suitable for use in preparing products for use in the paper industry, but may also be used in the practice of the present invention. In all three processes, a calcium carbonate feed material, such as limestone, is first calcined to produce quicklime, and the quicklime is then slaked in water to yield calcium hydroxide or milk of lime. In the first process, the milk of lime is directly carbonated with carbon dioxide gas. This process has the advantage that no by-product is formed, and it is relatively easy to control the properties and purity of the calcium carbonate product. In the second process the milk of lime is contacted with soda ash to produce, by double decomposition, a precipitate of calcium carbonate and a solution of sodium hydroxide. The sodium hydroxide may be substantially completely separated from the calcium carbonate if this process is used commercially. In the third main commercial process the milk of lime is first contacted with ammonium chloride to give a calcium chloride solution and ammonia gas. The calcium chloride solution is then contacted with soda ash to produce by double decomposition precipitated calcium carbonate and a solution of sodium chloride. The crystals can be produced in a variety of different shapes and sizes, depending on the specific reaction process that is used. The three main forms of PCC crystals are aragonite, rhombohedral and scalenohedral, all of which are suitable for use in the present invention, including mixtures thereof.

Wet grinding of calcium carbonate involves the formation of an aqueous suspension of the calcium carbonate which may then be ground, optionally in the presence of a suitable dispersing agent. Reference may be made to, for example, EP 614948 (the contents of which are incorporated by reference in their entirety) for more information regarding the wet grinding of calcium carbonate.

In some circumstances, minor additions of other minerals may be included, for example, one or more of kaolin, calcined kaolin, wollastonite, bauxite, talc or mica, could also be present.

When the inorganic particulate material of the present invention is obtained from naturally occurring sources, it may be that some mineral impurities will contaminate the ground material. For example, naturally occurring calcium carbonate can be present in association with other minerals. Thus, in some embodiments, the inorganic particulate material includes an amount of impurities. In general, however, the inorganic particulate material used in the invention will contain less than about 5% by weight, preferably less than about 1% by weight, of other mineral impurities.

The inorganic particulate material used during the microfibrillating step of the method of the present invention will preferably have a particle size distribution in which at least about 10% by weight of the particles have an e.s.d. of less than 2 µm, for example, at least about 20% by weight, or at least about 30% by weight, or at least about 40% by weight, or at least about 50% by weight, or at least about 60% by weight, or at least about 70% by weight, or at least about 80% by weight, or at least about 90% by weight, or at least about 95% by weight, or about 100% of the particles have an e.s.d. of less than 2 µm.

Unless otherwise stated, particle size properties referred to herein for the inorganic particulate materials are as measured in a well-known manner by sedimentation of the particulate material in a fully dispersed condition in an aqueous medium using a Sedigraph 5100 machine as supplied by Micromeritics Instruments Corporation, Norcross, Ga., USA (telephone: + 1 770 662 3620; web-site: www.micromeritics.com), referred to herein as a “Micromeritics Sedigraph 5100 unit”. Such a machine provides measurements and a plot of the cumulative percentage by weight of particles having a size, referred to in the art as the “equivalent spherical diameter” (e.s.d), less than given e.s.d. values. The mean particle size d₅₀ is the value determined in this way of the particle e.s.d. at which there are 50% by weight of the particles which have an equivalent spherical diameter less than that d₅₀ value.

Alternatively, where stated, the particle size properties referred to herein for the inorganic particulate materials are as measured by the well-known conventional method employed in the art of laser light scattering, using a Malvern Insitec apparatus (or equivalent), as supplied by Malvern Instruments Ltd (or by other methods which give essentially the same result). In the laser light scattering technique, the size of particles in powders, suspensions and emulsions may be measured using the diffraction of a laser beam, based on an application of Mie theory. Such a machine provides measurements and a plot of the cumulative percentage by volume of particles having a size, referred to in the art as the “equivalent spherical diameter” (e.s.d.), less than given e.s.d. values. The mean particle size d₅₀ is the value determined in this way of the particle e.s.d. at which there are 50% by volume of the particles which have an equivalent spherical diameter less than that d₅₀ value.

Unless otherwise stated, particle size properties of the microfibrillated cellulose materials are as are as measured by the well-known conventional method employed in the art of laser light scattering, using a Malvern Insitec L machine as supplied by Malvern Instruments Ltd (or by other methods which give essentially the same result).

Details of the procedure used to characterize the particle size distributions of mixtures of inorganic particle material and microfibrillated cellulose using a Malvern Mastersizer S machine are provided below.

Another preferred inorganic particulate material for use is kaolin clay. Hereafter, this section of the specification may tend to be discussed in terms of kaolin, and in relation to aspects where the kaolin is processed and/or treated. The invention should not be construed as being limited to such embodiments. Thus, in some embodiments, kaolin is used in an unprocessed form.

Kaolin clay used in this invention may be a processed material derived from a natural source, namely raw natural kaolin clay mineral. The processed kaolin clay may typically contain at least about 50% by weight kaolinite. For example, most commercially processed kaolin clays contain greater than about 75% by weight kaolinite and may contain greater than about 90%, in some cases greater than about 95% by weight of kaolinite.

Kaolin clay used in the present invention may be prepared from the raw natural kaolin clay mineral by one or more other processes which are well known to those skilled in the art, for example by known refining or beneficiation steps.

For example, the clay mineral may be bleached with a reductive bleaching agent, such as sodium hydrosulfite. If sodium hydrosulfite is used, the bleached clay mineral may optionally be dewatered, and optionally washed and again optionally dewatered, after the sodium hydrosulfite bleaching step.

The clay mineral may be treated to remove impurities, e.g. by flocculation, flotation, or magnetic separation techniques well known in the art. Alternatively the clay mineral used in the first aspect of the invention may be untreated in the form of a solid or as an aqueous suspension.

The process for preparing the particulate kaolin clay used in the present invention may also include one or more comminution steps, e.g., grinding or milling. Light comminution of a coarse kaolin is used to give suitable delamination thereof. The comminution may be carried out by use of beads or granules of a plastic (e.g. nylon), sand or ceramic grinding or milling aid. The coarse kaolin may be refined to remove impurities and improve physical properties using well known procedures. The kaolin clay may be treated by a known particle size classification procedure, e.g., screening and centrifuging (or both), to obtain particles having a desired d₅₀ value or particle size distribution.

### Fibrous Substrate Comprising Cellulose

The fibrous substrate comprising cellulose may be derived from any suitable source, such as wood, grasses (e.g., sugarcane, bamboo) or rags (e.g., textile waste, cotton, hemp or flax). The fibrous substrate comprising cellulose may be in the form of a pulp (i.e., a suspension of cellulose fibres in water), which may be prepared by any suitable chemical or mechanical treatment, or combination thereof. For example, the pulp may be a chemical pulp, or a chemithermomechanical pulp, or a mechanical pulp, or a recycled pulp, or a papermill broke, or a papermill waste stream, or waste from a papermill, or a combination thereof. The cellulose pulp may be beaten (for example in a Valley beater) and/or otherwise refined (for example, processing in a conical or plate refiner) to any predetermined freeness, reported in the art as Canadian standard freeness (CSF) in cm³. CSF means a value for the freeness or drainage rate of pulp measured by the rate that a suspension of pulp may be drained. For example, the cellulose pulp may have a Canadian standard freeness of about 10 cm³ or greater prior to being microfibrillated. The cellulose pulp may have a CSF of about 700 cm³ or less, for example, equal to or less than about 650 cm³, or equal to or less than about 600 cm³, or equal to or less than about 550 cm³, or equal to or less than about 500 cm³, or equal to or less than about 450 cm³, or equal to or less than about 400 cm³, or equal to or less than about 350 cm³, or equal to or less than about 300 cm³, or equal to or less than about 250 cm³, or equal to or less than about 200 cm³, or equal to or less than about 150 cm³, or equal to or less than about 100 cm³, or equal to or less than about 50 cm³. The cellulose pulp may then be dewatered by methods well known in the art, for example, the pulp may be filtered through a screen in order to obtain a wet sheet comprising at least about 10% solids, for example at least about 15% solids, or at least about 20% solids, or at least about 30% solids, or at least about 40% solids. The pulp may be utilized in an unrefined state, that is to say, without being beaten or dewatered, or otherwise refined.

The cellulose pulp may be beaten (for example in a Valley beater) and/or otherwise refined (for example, processing in a conical or plate refiner) to any predetermined freeness, reported in the art as Canadian standard freeness (CSF) in cm³. CSF means a value for the freeness or drainage rate of pulp measured by the rate that a suspension of pulp may be drained, and this test is carried out according to the T 227 cm-09 TAPPI standard. For example, the cellulose pulp may have a Canadian standard freeness of about 10 cm³ or greater prior to being microfibrillated. The cellulose pulp may have a CSF of about 700 cm³ or less, for example, equal to or less than about 650 cm³, or equal to or less than about 600 cm³, or equal to or less than about 550 cm³, or equal to or less than about 500 cm³, or equal to or less than about 450 cm³, or equal to or less than about 400 cm³, or equal to or less than about 350 cm³, or equal to or less than about 300 cm³, or equal to or less than about 250 cm³, or equal to or less than about 200 cm³, or equal to or less than about 150 cm³, or equal to or less than about 100 cm³, or equal to or less than about 50 cm³. The cellulose pulp may have a CSF of about 20 to about 700. The cellulose pulp may then be dewatered by methods well known in the art, for example, the pulp may be filtered through a screen in order to obtain a wet sheet comprising at least about 10% solids, for example at least about 15% solids, or at least about 20% solids, or at least about 30% solids, or at least about 40% solids. The pulp may be utilized in an unrefined state, that is to say, without being beaten or dewatered, or otherwise refined.

Microfibrillated cellulose may be produced by any method of reducing the particle size of polysaccharides as would be known to a person of ordinary skill in the art. However, methods for reducing particle size while preserving a high aspect ratio in the polysaccharide are preferred. In particular, the at least one microfibrillated cellulose may be produced by a method selected from the group consisting of grinding; sonication; homogenization; impingement mixer; heat; steam explosion; pressurization-depressurization cycle; freeze-thaw cycle; impact; grinding (such as a disc grinder); pumping; mixing; ultrasound; microwave explosion; and/or milling. Various combinations of these may also be used, such as milling followed by homogenization. In one embodiment, the at least one microfibrillated cellulose is formed by subjecting one or more cellulose-containing raw materials to a sufficient amount of shear in an aqueous suspension such that a portion of the crystalline regions of the cellulose fibers in the one or more cellulose-containing raw materials are fibrillated.

Microfibrillation of the fibrous substrate comprising cellulose may be obtained under wet conditions in the presence of the inorganic particulate material by a method in which the mixture of cellulose pulp and inorganic particulate material is pressurized (for example, to a pressure of about 500 bar) and then passed to a zone of lower pressure. The rate at which the mixture is passed to the low pressure zone is sufficiently high and the pressure of the low pressure zone is sufficiently low as to cause microfibrillation of the cellulose fibres. For example, the pressure drop may be obtained by forcing the mixture through an annular opening that has a narrow entrance orifice with a much larger exit orifice. The drastic decrease in pressure as the mixture accelerates into a larger volume (i.e., a lower pressure zone) induces cavitation which causes microfibrillation. In an embodiment, microfibrillation of the fibrous substrate comprising cellulose may be obtained in a homogenizer under wet conditions in the presence of the inorganic particulate material. In the homogenizer, the cellulose pulp-inorganic particulate material mixture is pressurized (for example, to a pressure of about 500 bar), and forced through a small nozzle or orifice. The mixture may be pressurized to a pressure of from about 100 to about 1000 bar, for example to a pressure of equal to or greater than 300 bar, or equal to or greater than about 500, or equal to or greater than about 200 bar, or equal to or greater than about 700 bar. The homogenization subjects the fibres to high shear forces such that as the pressurized cellulose pulp exits the nozzle or orifice, cavitation causes microfibrillation of the cellulose fibres in the pulp. Additional water may be added to improve flowability of the suspension through the homogenizer. The resulting aqueous suspension comprising microfibrillated cellulose and inorganic particulate material may be fed back into the inlet of the homogenizer for multiple passes through the homogenizer. In a preferred embodiment, the inorganic particulate material is a naturally platy mineral, such as kaolin. As such, homogenization not only facilitates microfibrillation of the cellulose pulp, but also facilitates delamination of the platy particulate material.

The microfibrillated cellulose may be in the form of at least one of a dispersion (e.g., in a gel or gelatinous form), a diluted dispersion, and/or in a suspension.

### Microfibrillated Cellulose Prepared Without Addition of Inorganic Particulate Material

In a preferred embodiment, the microfibrillated cellulose is prepared in accordance with a method comprising a step of microfibrillating a fibrous substrate comprising cellulose in an aqueous environment by grinding in the presence of a grinding medium which is to be removed after the completion of grinding, wherein the grinding is performed in a tower mill or a screened grinder, and wherein the grinding is carried out in the absence of grindable inorganic particulate material.

A stirred media mill consists of a rotating impeller that transfers kinetic energy to small grinding media beads, which grind down the charge via a combination of shear, compressive, and impact forces. A variety of grinding apparatus may be used to produce MFC by the disclosed methods herein, including, for example, a tower mill, a screened grinding mill, or a stirred media detritor.

A grindable inorganic particulate material is a material which would be ground in the presence of the grinding medium.

The particulate grinding medium may be of a natural or a synthetic material. The grinding medium may, for example, comprise balls, beads or pellets of any hard mineral, ceramic or metallic material. Such materials may include, for example, alumina, zirconia, zirconium silicate, aluminum silicate or the mullite-rich material which is produced by calcining kaolinitic clay at a temperature in the range of from about 1300° C. to about 1800° C. For example, in some embodiments a Carbolite® grinding media is preferred. Alternatively, particles of natural sand of a suitable particle size may be used.

Generally, the type of and particle size of grinding medium to be selected for use in the invention may be dependent on the properties, e.g., the particle size of-, and the chemical composition of, the feed suspension of material to be ground. Preferably, the particulate grinding medium comprises particles having an average diameter in the range of from about 0.5 mm to about 6 mm. In one embodiment, the particles have an average diameter of at least about 3 mm.

The grinding medium may comprise particles having a specific gravity of at least about 2.5. The grinding medium may comprise particles have a specific gravity of at least about 3, or least about 4, or least about 5, or at least about 6.

The grinding medium (or media) may be present in an amount up to about 70% by volume of the charge. The grinding media may be present in amount of at least about 10% by volume of the charge, for example, at least about 20% by volume of the charge, or at least about 30% by volume of the charge, or at least about 40% by volume of the charge, or at least about 50% by volume of the charge, or at least about 60% by volume of the charge.

The fibrous substrate comprising cellulose may be microfibrillated to obtain microfibrillated cellulose having a d∞) ranging from about 5 µm to about 500 µm, as measured by laser light scattering. The fibrous substrate comprising cellulose may be microfibrillated to obtain microfibrillated cellulose having a d₅₀ of equal to or less than about 400 µm, for example equal to or less than about 300 µm, or equal to or less than about 200 µm, or equal to or less than about 150 µm, or equal to or less than about 125 µm, or equal to or less than about 100 µm, or equal to or less than about 90 µm, or equal to or less than about 80 µm, or equal to or less than about 70 µm, or equal to or less than about 60 µm, or equal to or less than about 50 µm, or equal to or less than about 40 µm, or equal to or less than about 30 µm, or equal to or less than about 20 µm, or equal to or less than about 10 µm.

The fibrous substrate comprising cellulose may be microfibrillated to obtain microfibrillated cellulose having a modal fibre particle size ranging from about 0.1-500 µm. The fibrous substrate comprising cellulose may be microfibrillated in the presence to obtain microfibrillated cellulose having a modal fibre particle size of at least about 0.5 µm, for example at least about 10 µm, or at least about 50 µm, or at least about 100 µm, or at least about 150 µm, or at least about 200 µm, or at least about 300 µm, or at least about 400 µm.

The fibrous substrate comprising cellulose may be microfibrillated to obtain microfibrillated cellulose having a fibre steepness equal to or greater than about 10, as measured by Malvern. Fibre steepness (i.e., the steepness of the particle size distribution of the fibres) is determined by the following formula:

$$\text{Steepness} = 100 \times \left({\text{d}}_{\text{30}} / {\text{d}}_{\text{70}}\right)$$

The microfibrillated cellulose may have a fibre steepness equal to or less than about 100. The microfibrillated cellulose may have a fibre steepness equal to or less than about 75, or equal to or less than about 50, or equal to or less than about 40, or equal to or less than about 30. The microfibrillated cellulose may have a fibre steepness from about 20 to about 50, or from about 25 to about 40, or from about 25 to about 35, or from about 30 to about 40. In an embodiment, a preferred steepness range is about 20 to about 50.

In one embodiment, the grinding vessel is a tower mill. The tower mill may comprise a quiescent zone above one or more grinding zones. A quiescent zone is a region located towards the top of the interior of a tower mill in which minimal or no grinding takes place and comprises microfibrillated cellulose and inorganic particulate material. The quiescent zone is a region in which particles of the grinding medium sediment down into the one or more grinding zones of the tower mill.

The tower mill may comprise a classifier above one or more grinding zones. In an embodiment, the classifier is top mounted and located adjacent to a quiescent zone. The classifier may be a hydrocyclone.

The tower mill may comprise a screen above one or more grind zones. In an embodiment, a screen is located adjacent to a quiescent zone and/or a classifier. The screen may be sized to separate grinding media from the product aqueous suspension comprising microfibrillated cellulose and to enhance grinding media sedimentation.

In another embodiment, the microfibrillated cellulose may be prepared in a stirred media detritor. A stirred media mill consists of a rotating impeller that transfers kinetic energy to small grinding media beads, which grind down the charge via a combination of shear, compressive, and impact forces. A variety of grinding apparatus may be used to produce MFC by the disclosed methods herein, including, for example, a tower mill, a screened grinding mill, or a stirred media detritor.

In an embodiment, the grinding is performed under plug flow conditions. Under plug flow conditions the flow through the tower is such that there is limited mixing of the grinding materials through the tower. This means that at different points along the length of the tower mill the viscosity of the aqueous environment will vary as the fineness of the microfibrillated cellulose increases. Thus, in effect, the grinding region in the tower mill can be considered to comprise one or more grinding zones which have a characteristic viscosity. A skilled person in the art will understand that there is no sharp boundary between adjacent grinding zones with respect to vi scosity.

In an embodiment, water is added at the top of the mill proximate to the quiescent zone or the classifier or the screen above one or more grinding zones to reduce the viscosity of the aqueous suspension comprising microfibrillated cellulose at those zones in the mill. By diluting the product microfibrillated cellulose at this point in the mill it has been found that the prevention of grinding media carry over to the quiescent zone and/or the classifier and/or the screen is improved. Further, the limited mixing through the tower allows for processing at higher solids lower down the tower and dilute at the top with limited backflow of the dilution water back down the tower into the one or more grinding zones. Any suitable amount of water which is effective to dilute the viscosity of the product aqueous suspension comprising microfibrillated cellulose may be added. The water may be added continuously during the grinding process, or at regular intervals, or at irregular intervals.

In another embodiment, water may be added to one or more grinding zones via one or more water injection points positioned along the length of the tower mill, the or each water injection point being located at a position which corresponds to the one or more grinding zones. Advantageously, the ability to add water at various points along the tower allows for further adjustment of the grinding conditions at any or all positions along the mill.

The tower mill may comprise a vertical impeller shaft equipped with a series of impeller rotor disks throughout its length. The action of the impeller rotor disks creates a series of discrete grinding zones throughout the mill.

In another embodiment, the grinding is performed in a screened grinder, preferably a stirred media detritor. The screened grinder may comprise one or more screen(s) having a nominal aperture size of at least about 250 µm, for example, the one or more screens may have a nominal aperture size of at least about 300 µm, or at least about 350 µm, or at least about 400 µm, or at least about 450 µm, or at least about 500 µm, or at least about 550 µm, or at least about 600 µm, or at least about 650 µm, or at least about 700 µm, or at least about 750 µm, or at least about 800 µm, or at least about 850 µm, or at or least about 900 µm, or at least about 1000 µm.

The screen sizes noted immediately above are applicable to the tower mill embodiments described above.

As noted above, the grinding is performed in the presence of a grinding medium. In an embodiment, the grinding medium is a coarse media comprising particles having an average diameter in the range of from about 1 mm to about 6 mm, for example about 2 mm, or about 3 mm, or about 4 mm, or about 5 mm.

In another embodiment, the grinding media has a specific gravity of at least about 2.5, for example, at least about 3, or at least about 3.5, or at least about 4.0, or at least about 4.5, or least about 5.0, or at least about 5.5, or at least about 6.0.

As described above, the grinding medium (or media) may be in an amount up to about 70% by volume of the charge. The grinding media may be present in amount of at least about 10% by volume of the charge, for example, at least about 20% by volume of the charge, or at least about 30% by volume of the charge, or at least about 40% by volume of the charge, or at least about 50% by volume of the charge, or at least about 60% by volume of the charge.

In one embodiment, the grinding medium is present in amount of about 50% by volume of the charge.

By ‘charge’ is meant the composition which is the feed fed to the grinder vessel. The charge includes water, grinding media, the fibrous substrate comprising cellulose and any other optional additives (other than as described herein).

The use of a relatively coarse and/or dense media has the advantage of improved (i.e., faster) sediment rates and reduced media carry over through the quiescent zone and/or classifier and/or screen(s).

A further advantage in using relatively coarse screens is that a relatively coarse or dense grinding media can be used in the microfibrillating step. In addition, the use of relatively coarse screens (i.e., having a nominal aperture of least about 250 µm) allows a relatively high solids product to be processed and removed from the grinder, which allows a relatively high solids feed (comprising fibrous substrate comprising cellulose and inorganic particulate material) to be processed in an economically viable process. As discussed below, it has been found that a feed having a high initial solids content is desirable in terms of energy sufficiency. Further, it has also been found that product produced (at a given energy) at lower solids has a coarser particle size distribution.

In accordance with one embodiment, the fibrous substrate comprising cellulose is present in the aqueous environment at an initial solids content of at least about 1 wt%. The fibrous substrate comprising cellulose may be present in the aqueous environment at an initial solids content of at least about 2 wt%, for example at least about 3 wt%, or at least about at least 4 wt%. Typically the initial solids content will be no more than about 10 wt%.

In another embodiment, the grinding is performed in a cascade of grinding vessels, one or more of which may comprise one or more grinding zones. For example, the fibrous substrate comprising cellulose may be ground in a cascade of two or more grinding vessels, for example, a cascade of three or more grinding vessels, or a cascade of four or more grinding vessels, or a cascade of five or more grinding vessels, or a cascade of six or more grinding vessels, or a cascade of seven or more grinding vessels, or a cascade of eight or more grinding vessels, or a cascade of nine or more grinding vessels in series, or a cascade comprising up to ten grinding vessels. The cascade of grinding vessels may be operatively inked in series or parallel or a combination of series and parallel. The output from and/or the input to one or more of the grinding vessels in the cascade may be subjected to one or more screening steps and/or one or more classification steps.

The total energy expended in a microfibrillation process may be apportioned equally across each of the grinding vessels in the cascade. Alternatively, the energy input may vary between some or all of the grinding vessels in the cascade.

A person skilled in the art will understand that the energy expended per vessel may vary between vessels in the cascade depending on the amount of fibrous substrate being microfibrillated in each vessel, and optionally the speed of grind in each vessel, the duration of grind in each vessel and the type of grinding media in each vessel. The grinding conditions may be varied in each vessel in the cascade in order to control the particle size distribution of the microfibrillated cellulose.

In an embodiment the grinding is performed in a closed circuit. In another embodiment, the grinding is performed in an open circuit.

As the suspension of material to be ground may be of a relatively high viscosity, a suitable dispersing agent may preferably be added to the suspension prior to grinding. The dispersing agent may be, for example, a water soluble condensed phosphate, polysilicic acid or a salt thereof, or a polyelectrolyte, for example a water soluble salt of a poly(acrylic acid) or of a poly(methacrylic acid) having a number average molecular weight not greater than 80,000. The amount of the dispersing agent used would generally be in the range of from 0.1 to 2.0% by weight, based on the weight of the dry inorganic particulate solid material. The suspension may suitably be ground at a temperature in the range of from 4° C. to 100° C.

Other additives which may be included during the microfibrillation step include: carboxymethyl cellulose, amphoteric carboxymethyl cellulose, oxidising agents, 2,2,6,6-Tetramethylpiperidine-1-oxyl (TEMPO), TEMPO derivatives, and wood degrading enzymes.

The pH of the suspension of material to be ground may be about 7 or greater than about 7 (i.e., basic), for example, the pH of the suspension may be about 8, or about 9, or about 10, or about 11. The pH of the suspension of material to be ground may be less than about 7 (i.e., acidic), for example, the pH of the suspension may be about 6, or about 5, or about 4, or about 3. The pH of the suspension of material to be ground may be adjusted by addition of an appropriate amount of acid or base. Suitable bases included alkali metal hydroxides, such as, for example NaOH. Other suitable bases are sodium carbonate and ammonia. Suitable acids included inorganic acids, such as hydrochloric and sulphuric acid, or organic acids. An exemplary acid is orthophosphoric acid.

The total energy input in a typical grinding process to obtain the desired aqueous suspension composition may typically be between about 100 and 1500 kWht⁻¹ based on the total dry weight of the inorganic particulate filler. The total energy input may be less than about 1000 kWht⁻¹, for example, less than about 800 kWht⁻¹, less than about 600 kWht⁻¹, less than about 500 kWht⁻¹, less than about 400 kWht⁻¹, less than about 300 kWht⁻¹, or less than about 200 kWht⁻¹. As such, the present inventors have surprisingly found that a cellulose pulp can be microfibrillated at relatively low energy input when it is co-ground in the presence of an inorganic particulate material. As will be apparent, the total energy input per tonne of dry fibre in the fibrous substrate comprising cellulose will be less than about 10,000 kWht⁻¹, for example, less than about 9000 kWht⁻¹, or less than about 8000 kWht⁻¹, or less than about 7000 kWht⁻¹, or less than about 6000 kWht⁻¹, or less than about 5000 kWht⁻¹ for example less than about 4000 kWht⁻¹, less than about 3000 kWht⁻¹, less than about 2000 kWht⁻¹, less than about 1500 kWht⁻¹, less than about 1200 kWht⁻¹, less than about 1000 kWht⁻¹, or less than about 800 kWhf⁻¹. The total energy input varies depending on the amount of dry fibre in the fibrous substrate being microfibrillated, and optionally the speed of grind and the duration of grind.

### Mechanical Properties of Microfibrillated Cellulose

The re-dispersed microfibrillated cellulose has a mechanical and/or physical property which is closer to that of the microfibrillated cellulose prior to drying or at least partial drying.

The mechanical property may be any determinable mechanical property associated with microfibrillated cellulose. For example, the mechanical property may be a strength property, for example, tensile index. Tensile index may be measured using a tensile tester. Any suitable method and apparatus may be used provided it is controlled in order to compare the tensile index of the microfibrillated cellulose before drying and after re-dispersal. For example, the comparison should be conducted at equal concentrations of microfibrillated cellulose, and any other additive or inorganic particulate material(s) which may be present. Tensile index may be expressed in any suitable units such as, for example, Nm/g or kNm/kg.

The physical property may be any determinable physical property associated with microfibrillated cellulose. For example, the physical property may be viscosity. Viscosity may be measured using a viscometer. Any suitable method and apparatus may be used provided it is controlled in order to compare the viscosity of the microfibrillated cellulose prior to drying and after re-dispersal. For example, the comparison should be conducted at equal concentrations of microfibrillated cellulose, and any other additive or inorganic particulate material(s) which may be present. In certain embodiments, the viscosity is Brookfield viscosity, with units of mPas.

In certain embodiments, the essentially completely-dried or partially-dried microfibrillated cellulose is prepared in accordance with the procedures of U.S. Pat. No. 10.001,644 which is incorporated by reference herein in its entirety.

In certain embodiments, the tensile index and/or viscosity of the re-dispersed microfibrillated cellulose is at least about 25% of the tensile index and/or viscosity of the aqueous composition of microfibrillated cellulose prior to drying, for example, at least about 30%, or at least about 35%, or at least about 40%, or at least 45%, or at least about 50%, or at least about 55%, or at least about 60%, or at least about 65%, or at least about 70%, or at least about 75%, or at least about 80% of the tensile index and/or viscosity of the microfibrillated cellulose prior to drying.

In certain embodiments, the viscosity of the re-dispersed microfibrillated cellulose is at least about 25% of the viscosity of the aqueous composition of microfibrillated cellulose prior to drying, for example, at least about 30%, or at least about 35%, or at least about 40%, or at least 45%, or at least about 50%, or at least about 55%, or at least about 60%, or at least about 65%, or at least about 70%, or at least about 75%, or at least about 80% of the viscosity of the microfibrillated cellulose prior to drying.

### Radial Flow Impeller

A radial flow impeller is capable of generating moderate-to-high shear mixing of suspended solids in a solvent, e.g., water. Such a radial flow impeller is exemplified by a Cowles-blade, where tip speeds less than 20 m/s are utilized with an impeller (D) to tank (T) diameter less than 0.5, i.e., D/T<0.5.

### Rotor-Stator Mixer

A rotor-stator imparts higher shear rates than a radial flow impeller in the mixing of suspended solids in a solvent, e.g., water. A rotor-stator apparatus is exemplified, for example, by a Trigonal® mixer. The rotor-stator mixer typically has tip speeds >20 m/s and an in-situ adjustable rotor-stator gap width of 0.1, 0.2, 0.3 mm and so on, depending on required shear-levels & physical limits of the design.

### Hydrocyclone

A hydrocyclone is an apparatus for separating or sorting particles in a liquid suspension based on the ratio of their centripetal force to fluid resistance. Generally a hydrocyclone comprises a base end and an apex end and a separation chamber having an elongated shape between the base end and the apex end. At least one inlet for feeding a cellulose-containing suspension to be cleaned is arranged at the base end, at least one underflow outlet is arranged at the apex end and at least one overflow outlet is arranged at the base end. In the present apparatus, an inlet flow primarily fed tangentially into the separation chamber is separated into an accept fraction and a reject fraction. The accept fraction is sent forward in the system for downstream processing. The reject fraction from the hydrocyclone underflow stage is returned to the rotor-stator mixer for further processing. A suspension is injected into the hydrocyclone in a manner that creates a vortex. Depending upon the relative densities of the phases, centrifugal acceleration causes the dispersed phase to move away from or towards the central core of the vortex. Hydrocyclone or cyclone devices are known for separating particles from liquid mixture by exploiting the centripetal force. By injecting the liquid mixture into a vessel and spinning therein, heavy or large particles move outward towards the wall of the vessel due to the centripetal force, and spirally move down to the bottom of the vessel. Light components move towards the center of the vessel and may be discharged via an outlet. This ratio is high for separation of coarse particles and low for separation of fine particles.

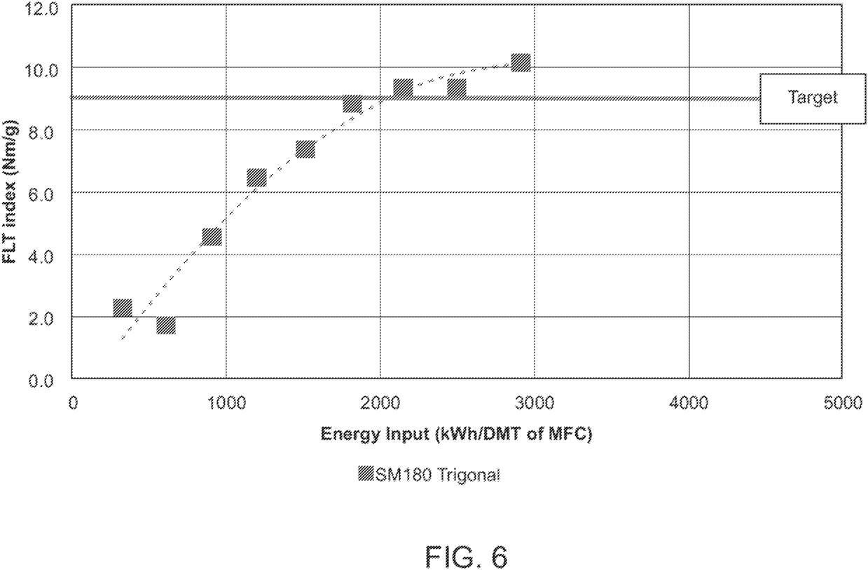

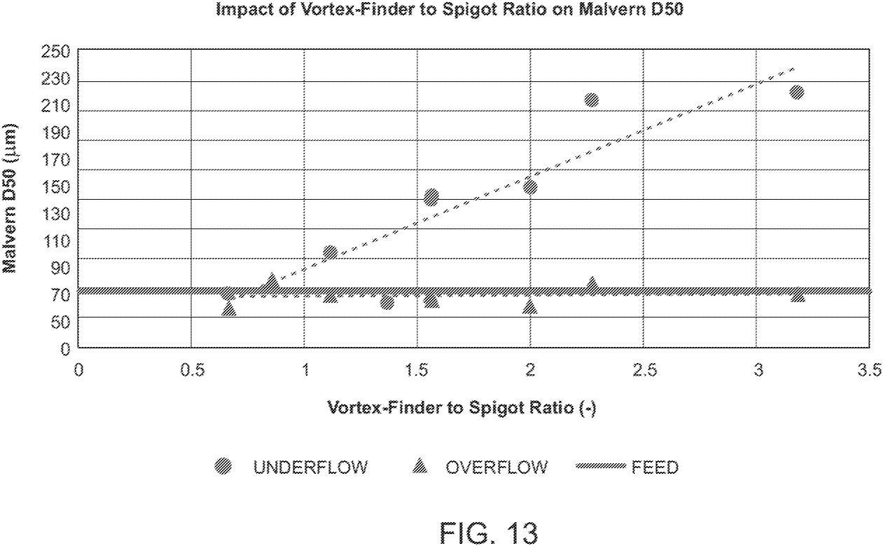

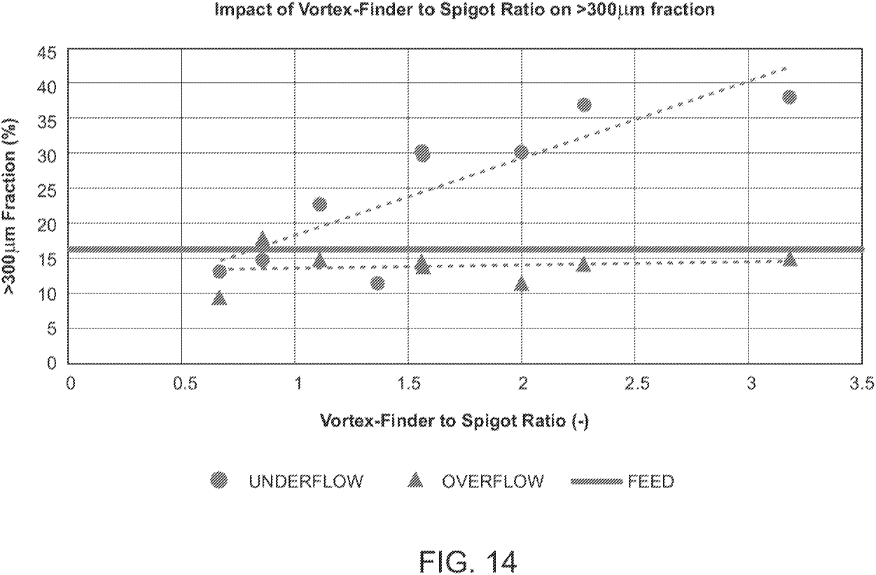

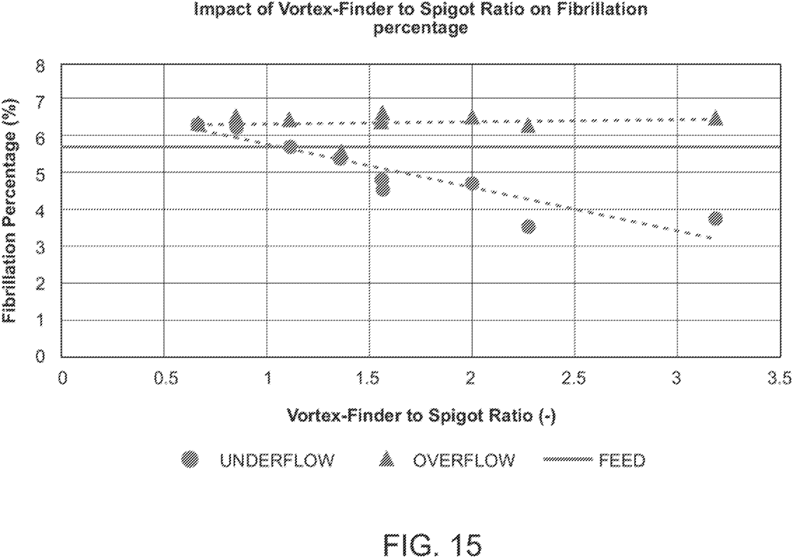

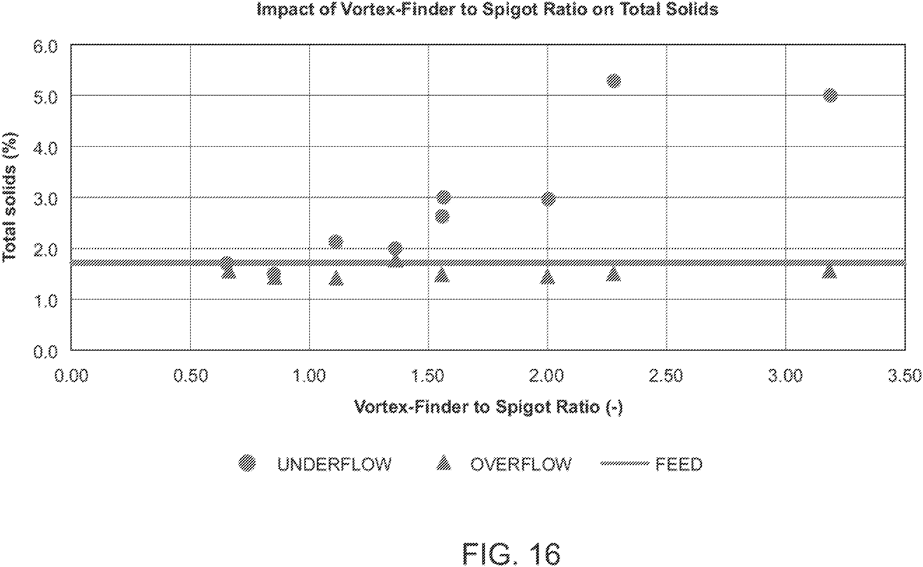

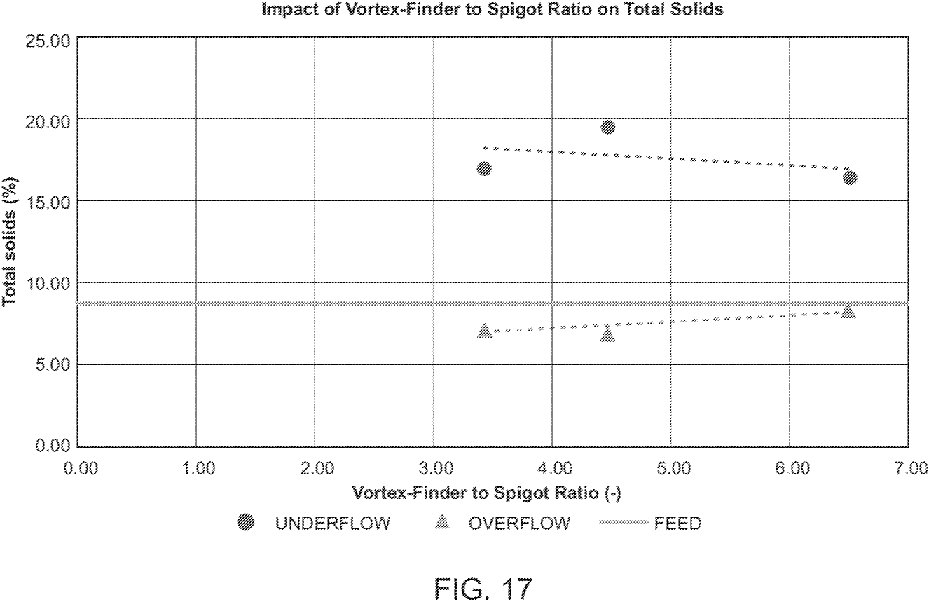

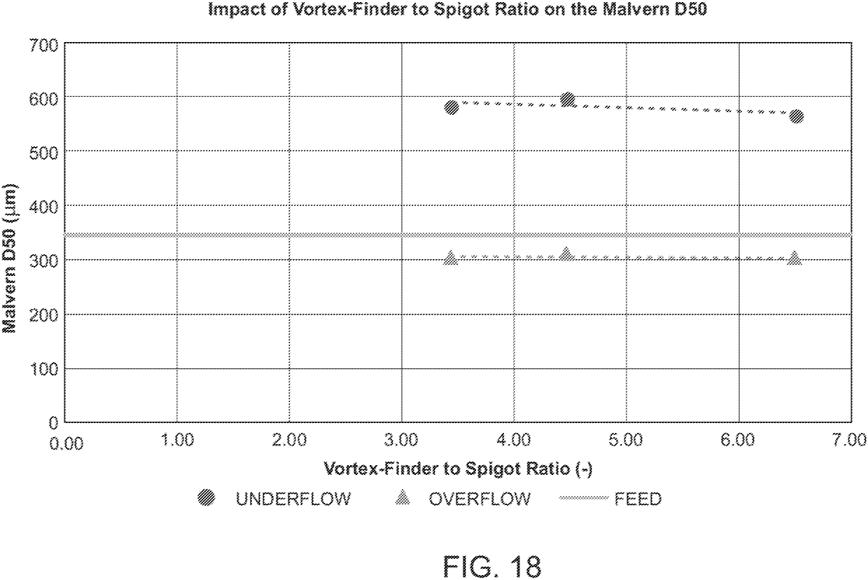

The impact of the vortex-finder to spigot ratio on Malvern D₅₀, the >300 µm fraction, the fibrillation percentage and total solids is presented in FIGS. 13, 14, 15 and 16, respectively. The fine stream and feed streams very closely resemble each other in terms of particle size distributions. The underflow stream is a more concentrated stream (i.e., more than 1.5 times the overflow total solids concentration as depicted in FIG. 6 that is coarser (more than 1.5 times the overflow D₅₀).

### EXAMPLES

### Example 1: Re-Dispersion of Microfibrillated Cellulose: FLT Index (Tensile Index) Test

The laboratory scale dispersion of microfibrillated cellulose and microfibrillated cellulose and microfibrillated cellulose and inorganic particulate material composite pressed-cake material into a slurry is achieved through the use of a high shear mixer called a Silverson®. These steps are performed to adequately disperse the pressed-cake into a homogeneous slurry, so that it can be used for hand sheet evaluations or quality control characterisation.

Place an empty, clean poise pot on the balance and tare. Weigh out FiberLean presscake material into poise pot. Based on the mass in the pot, dilute to 2% fibre solids using water (approx. 4% total solids for 50% MFC cake). Allow to soak for 1 hour. Mix on the Silverson® for 1 minute on full power. Re-measure the total solids content.

### ISO9001 Compliant

A laboratory procedure for making sheets from a pure microfibrillated cellulose or microfibrillated cellulose and inorganic particulate material composite sample on a custom-built filtration apparatus and measuring their strength.

Tensile Index Test: Microfibrillated cellulose FiberLean products at 20% Percentage of Pulp (POP) and above. Microfibrillated cellulose and microfibrillated cellulose and inorganic particulate material composites are adjusted to 20% POP by addition of filler. Sheets of approximately 220 gsm are made by dewatering the diluted microfibrillated cellulose and inorganic particulate material slurry on the filtration apparatus, then pressing and drying with a Rapid Köthen dryer. Tests required on the sheets are gsm and tensile strength.

Method for Microfibrillated Cellulose and Inorganic Particulate Material Composites. Record %solids and %POP of sample (see separate procedure). If%POP is greater than 20%, add mineral of the same type as in the microfibrillated cellulose and inorganic particulate material composite product to bring it to 20% (see separate procedure for microfibrillated cellulose and inorganic particulate material composite handsheets). If%POP is between 18% and 20% a correction factor will need to be applied to the result. Take approximately 4.4 g dry weight of sample (44 g for a 10% solids sample) and dilute with water to 400 mls to obtain a total solids of approximately 1.1% (0.22% fibre solids) - this will make a 220 gsm sheet on the 15.9 cm diameter exposed screen of the apparatus. Stir well to ensure good dispersion. Add 1 ml of the 0.2 wt% polyDADMAC solution to the diluted sample and stir well. If drainage is very slow this may be increased up to 5 ml. Remove the top section from the filtration unit and place a filter paper on top of the screen. Wet the filter paper with a wash bottle, and push any bubbles that form out to the rim of the paper. Ensure drain valve at bottom of unit is closed, then switch on the vacuum to adhere the filter to the screen, ensuring it sits flush with no creases. Replace the top section and clamp into place, then switch off vacuum and open drain valve to release vacuum and drain water. Close drain valve, then pour sample into top section over the end of a spatula or similar to ensure an even distribution. Avoid pouring sample directly onto filter paper. Allow sample to settle for a few seconds, then switch on vacuum and filter the sample. This should take approximately 2 minutes. Wait 1 minute then switch off vacuum supply and open drain valve to release vacuum and remove water from unit. Unclamp and remove top section of unit. Carefully remove the filter paper and filtered sample together. Place the sample and filter on a Rapid Köthen carrier board. Place a Rapid Kothen sheet cover over the sample. Place sample and covers into Rapid Köthen drier and dry for 7 minutes at -0.9 bar or -26.5 inch Hg pressure, if the vacuum pressure is lower then extended time will be required in the drier unit. Separate dry sample from filters and covers and condition at 23° C. +/- 2° C. and 50% RH +/- 5% for a minimum of 20 minutes

Testing. Weigh the sheet (4 d.p.) to determine its gsm. Cut sample into 15 mm wide strips using the cutter. A minimum of 5 strips is required. Measure force in Newtons required to break each strip with the tensile tester. Use Excel spreadsheet provided to calculate tensile index for each sample as in section 6.

Calculations. Area of sheet in m² (A) = 0.0001 × π × (diameter in cm)² /4 (0.0199 for 15.9 cm diameter sheet). Sheet gsm = Mass of sheet in grams / A. Mass of slurry required = 100 × 220 × A / TS (TS = %total solids). Microfibrillated cellulose and inorganic particulate material composite Tensile Index kN m kg⁻¹ (T) = 1000 × Fₘ / (W × gsm) where Fₘ = Max tensile force (N). W = Strip width (15 mm as standard) gsm = gsm of sample. Record the average tensile index and standard deviation of the 5 measurements in each case. If %POP is less than 20%, then tensile index should be corrected according to T_{corrected}= T/[1- 7.6*(0.2-%POP)].

Equipment check and calibration. Calibration and procedures follow those laid down in the following standards: Paper testing - T220 sp-96.

### Example 2: Viscosity Measurements. A Brookfield Viscosity Test for Microfibrillated Cellulose and Inorganic Particulate Material Composite Samples at 1.0% Fibre Solids Using Vane Spindle. Kaolin and Calcium Carbonate Based Microfibrillated Cellulose and Inorganic Particulate Material Composite Samples May Be Measured in the Following Manner

### Viscometer: Brookfield YR-1 or R.V. or Similar Instrument Including Vane Spindles

Method for Microfibrillated Cellulose and Inorganic Particulate Material Composite. Ensure that the slurry is homogenous by shaking the container and contents vigorously. Use a palette knife to scoop and transfer at least 100 ml to a polystyrene pot. Stir well with spatula (or spindle). Set the speed of the viscometer to the required speed (10 rpm) and switch on. Allow the spindle to rotate for 30 seconds. Note and record the viscometer reading, speed, and Vane number.

Viscosity Measurement at 1.0% Fibre Solids Contents. Mix the slurry thoroughly by shaking the container and contents vigorously. Transfer a representative portion (approximately 100 g) of the microfibrillated cellulose and inorganic particulate material composite slurry to a tarred polystyrene pot. Weigh and record the weight of the slurry. Calculate the water addition required to achieve 1.0% Fibre Solids content. Add the volume of de-ionised water required to give the specified test solids. The viscosity of the microfibrillated cellulose and inorganic particulate material composite is expressed in millipascal-second (mPa.s) and is calculated from the chart provided according to the manufacturer’s instruction. The standard deviation of a test slurry having a viscosity of 500 mPa.s is 5.

Calculating the Fibre Solids Contents.

$$\text{FS} = \text{TS} \times \text{POP} / \text{10}$$

Where FS = % Fibre Solids. TS = % Total Solids. POP = % Pulp on Product. Dilution Calculation. The volume of water required to give a dilution of D mass % is calculated as follows:-

$$\text{V} = \frac{\left(\text{I} - \text{R}\right)}{\text{R}} \times \text{W}$$

Where V = Volume of water required
I = Initial wt% Fibre solids
R = Required wt% Fibre Solids
W = the Weight of the slurry content in the pot

### Dilution Calculation - Total Solids Concentrations

The weight of mineral required to give a dilution of D mass % is calculated as follows:-

$$\text{M} = \left(\text{I} - \text{R}\right) \times \text{W} / \text{R}$$

Where M = the weight of Mineral required
I = Initial wt% total solids
R = Required wt% total solids
W = the Weight of the FibreLean slurry content in the pot

Mineral is the product used in the microfibrillated cellulose and inorganic particulate material composite slurry contents. (Carbonate or Kaolin).

%Total solids is obtained after the microfibrillated cellulose and inorganic particulate material composite slurry dried at 80 - 100° C.

%Pulp on Product (POP) is obtained after the “Total Solids” sample burned at 450° C. (Kaolin at 950° C.).

In the following Comparative Examples and Examples all experiments utilized a dry, powdered mixture of ground calcium carbonate (60% < 2 µm) and bleached softwood Kraft pulp. The total concentration was nominally 75% by weight and the concentration of pulp on dry product was 50% by weight.

The dry, powdered mixture of ground calcium carbonate (60% < 2 µm) and bleached softwood Kraft pulp was blended with water using different commercial equipment under optimum conditions as specified by their manufacturers. A combination of equipment was developed into a process that achieves a substantially homogeneous suspension.

The analysis of the re-dispersed microfibrillated cellulose compositions included: Tensile (FLT) strength, as described in Example 1 and apparent viscosity using a Brookfield vane spindle viscometer, as described in Example 2. Particle size distribution as measured by light scattering on the Malvern Insitec L, as described in Example 3.

### Particle Size Analyser: Malvern Insitec L

Method for Microfibrillated Cellulose and Inorganic Particle Material Composite.

Ensure that the slurry is homogenous by shaking the container and contents vigorously.

Switch the Malvern Insitec unit on and replace the water in the recirculation beaker with clean, room temperature ± 5° C. tap water (800 ml - 900 ml). Start the recirculation pump and ensure the pump speed setting is at 2500 RPM.

Open the Malvern ‘RTSizer’ software program on the computer desktop and perform a background measurement on the tap water.

Following the notification of a valid background measurement, enable particle size data collection via the ‘New Size History’ icon.

Using a pipette add the slurry into the recirculation beaker until a transmission of between 40% and 60% is reached.

At a transmission of 40 - 60%, allow the instrument to continue its measurement for a further 1 minute.

Use the ‘Malvern RTSizer’ software functions to average the 1 minute time-lapse of particle size history data and record the averaged size distribution parameters

Following data collection, the system is cleaned with tap water and de-ionised water to remove any residues on the window cell.

### Example 4: Control Trial 1

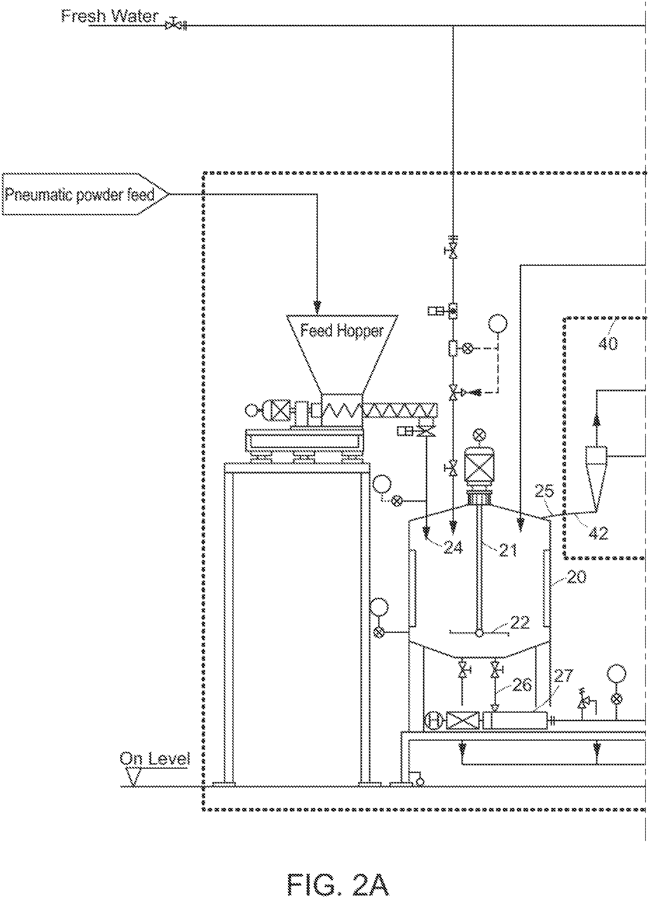

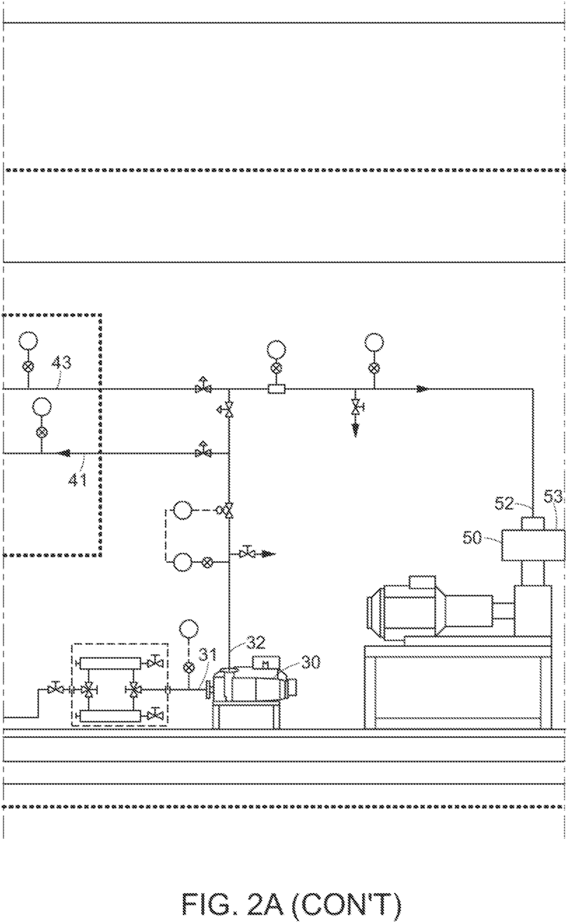

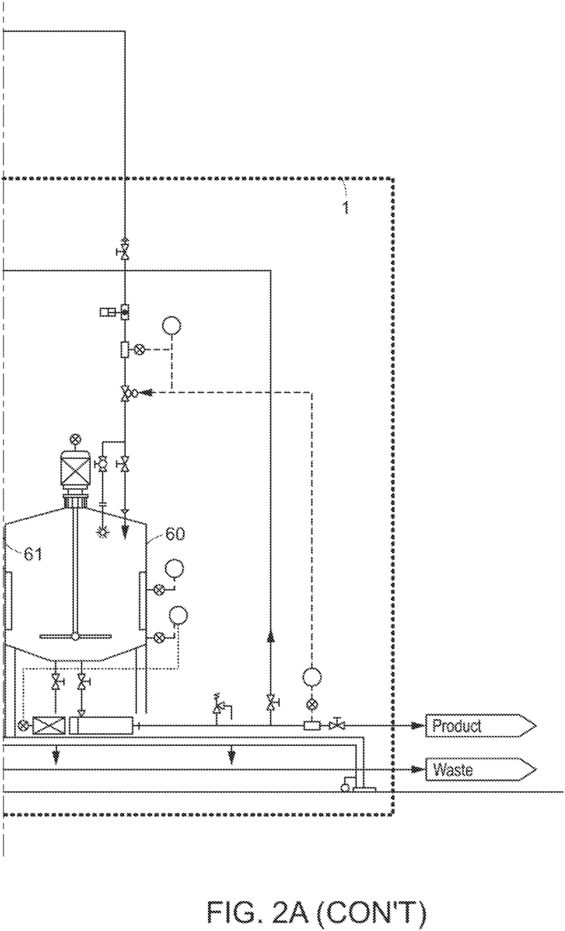

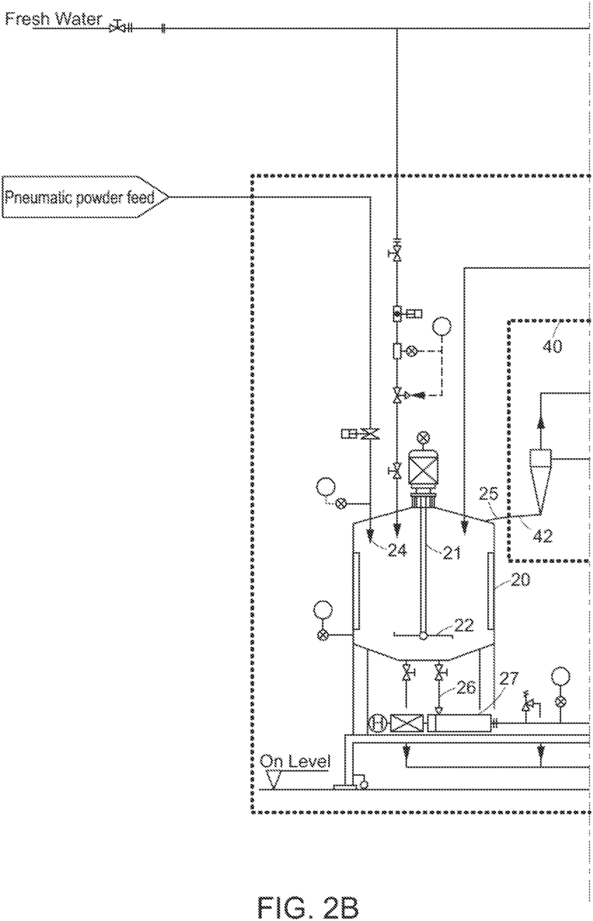

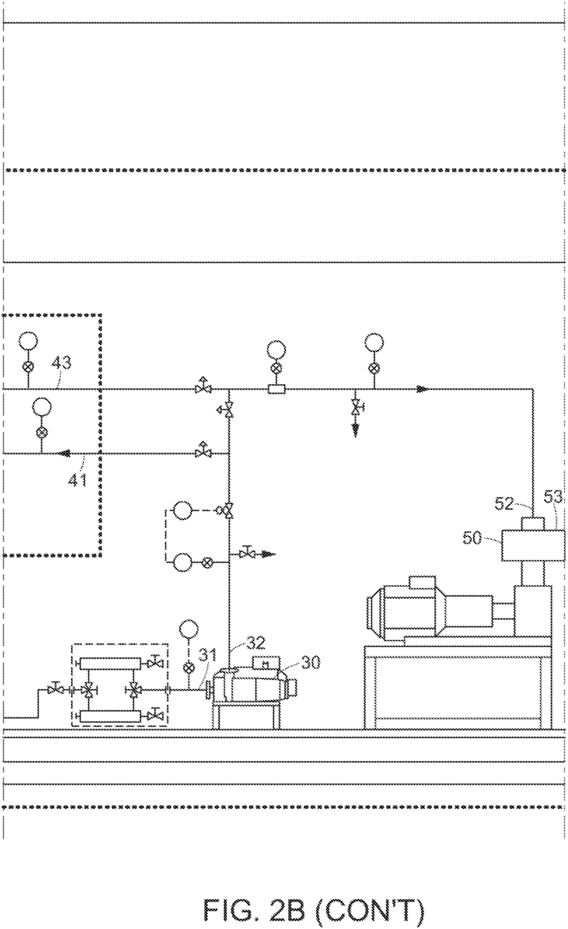

A system consisting of two Cowles-blade (saw-tooth shaped impeller) mixers in series with a high-shear rotor-stator in-line mixer, was used to re-disperse the dry, powdered mixture. FIGS. 2 below shows the control system.

The standard conditions for operating the equipment were 3.5% total solids (for 50% POP) and 100% speed on the BVG shear-master. The flow rate was kept low at 12 m³/h to maximise residence time in the tanks.

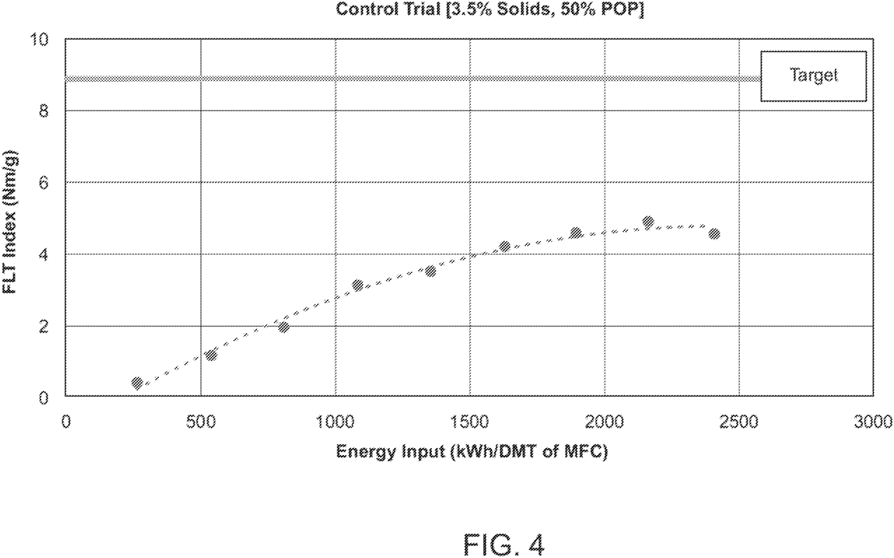

As seen in FIG. 4, the slurry failed on the main testing parameters (tensile strength and apparent viscosity) even after 2400 kWh/DMT of MFC specific energy input and 18 passes through the system.

### Example 5: Control Trial 2

A pilot-scale 12″ Sprout refiner was used to evaluate re-dispersion of the dry, powdered mixture. It is commonly used in the paper industry for pulp refining. The powder was blended with water in a Denver pulper before being recirculated around the 12″ Sprout refiner and a holding tank. The optimised conditions used were: 0.1 J/m intensity, 20 kWh/DMT of MFC net specific energy input per pass, 1320 RPM speed and disc design to give 1.111 km/rev of cutting-edge length. The total solids concentration was 9%. The percentage of pulp (POP) was 50%.

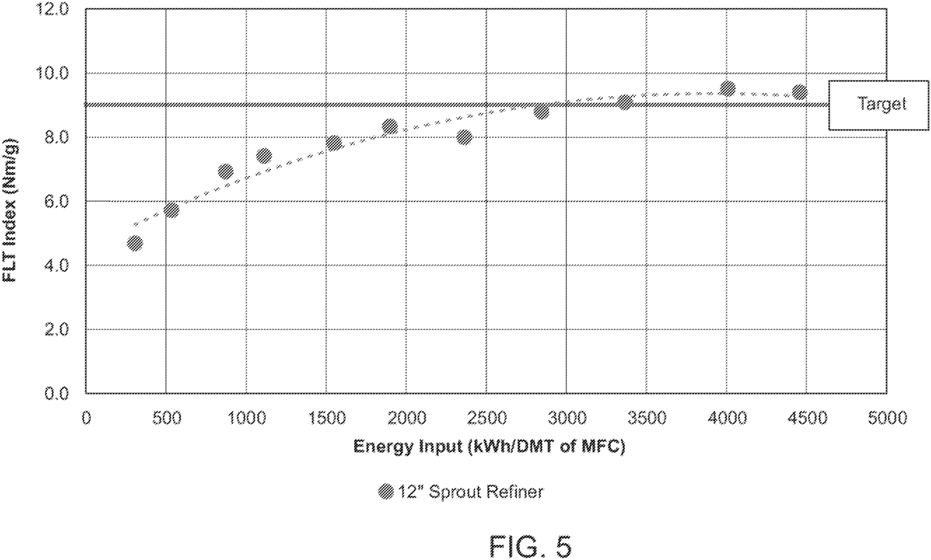

The results are shown in FIG. 5. The main quality parameters (tensile strength and apparent viscosity) return after 15 passes and 2840 kWh/DMT of MFC gross specific energy input. This unfortunately confines the process to a batch operation and the high energy consumption makes it economically unfeasible.

### Example 6: Control Trial 3

A Trigonal® SM180 was used to evaluate re-dispersion of the dry, powdered mixture. It is used commonly in the bitumen industry to blend additives uniformly into the mixture but also as a pulp de-flaker. The slurry was blended using a hand-held mixer in a small vessel and the blended slurry was contained in a hold-up tank. The hold-up tank was connected in recirculation with the Trigonal® SM180. The conditions chosen were determined to be optimum from a series of trials - W3 F.S. GL reduction tool (counter-cut groove pattern), 5400 RPM, 0.1 mm gap-setting and total solids concentration was 9%. The POP was 50%.

The results are shown in FIG. 6. The main quality parameters (tensile strength and viscosity) return after 18 passes and 1808 kWh/DMT of MFC gross specific energy input. This unfortunately confines it to a batch operation as well, with a high capital and operational cost.

### Example 7: Control Trial 4

An Atrex® by Megatrex Oy, was used to evaluate re-dispersion of the dry, powdered mixture. It is used commonly in the paper industry to re-disperse paper broke (waste run-off from paper-machine) and also in disintegrating coarse minerals. The most optimum conditions were selected - 2000 RPM rotation speed and 55 kg/min flow rate. Their standard 6-ring design was used. The counter-rotation of each segment generates very high shear-rates. The throughput is limited due to the high motor power requirements for generating such shear-rates in the fluid.

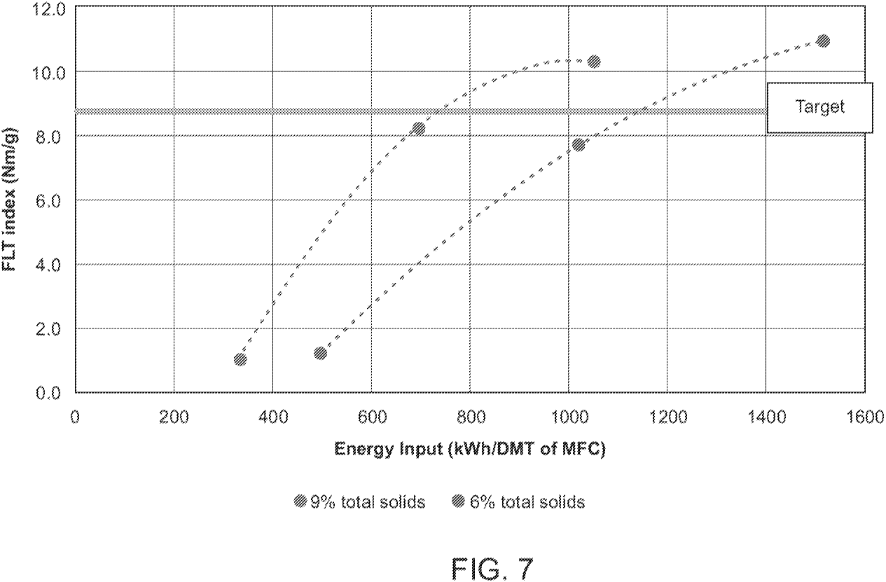

The results are shown in FIG. 7. The main quality parameters (tensile strength and apparent viscosity) are above the target in Pass 3 after 1000 kWh/DMT of MFC gross specific energy input using 9% total solids. After Pass 2, they appear close to the target with 700 kWh/DMT of MFC gross specific energy input at 9% total solids.

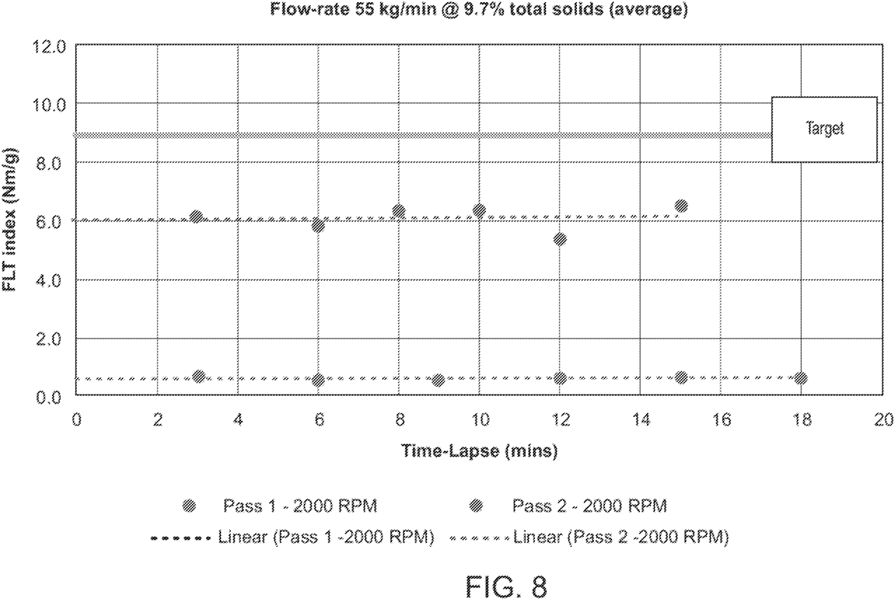

However, as shown in FIG. 8, on continuous operation, two passes are not sufficient for total re-dispersion of the product to the same quality parameters of the never-dried slurry. The system does not appear viable with the energy consumption and corresponding quality parameters. The Atrex® is a high capital cost equipment with a significantly large power consumption requirement per pass at fixed throughputs.

### Example 8: Control Trial 5

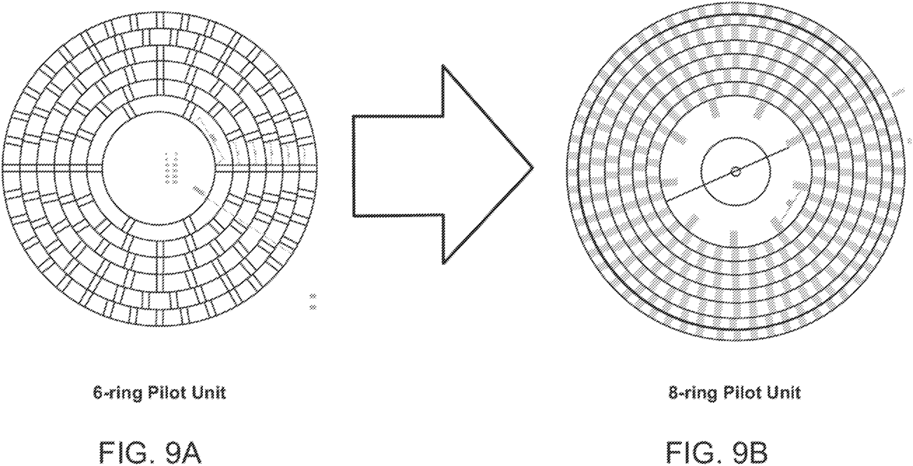

The Atrex® counter-rotating rings were upgraded after discussion with the engineering team at Megatrex. The existing 6-ring design (shown on the left in FIG. 9A) was redesigned to include more bars for maximum contact with the fibre/mineral particles in the slurry and a further two rings to extend shearing effect between the rings (as shown on the right in FIG. 9B.

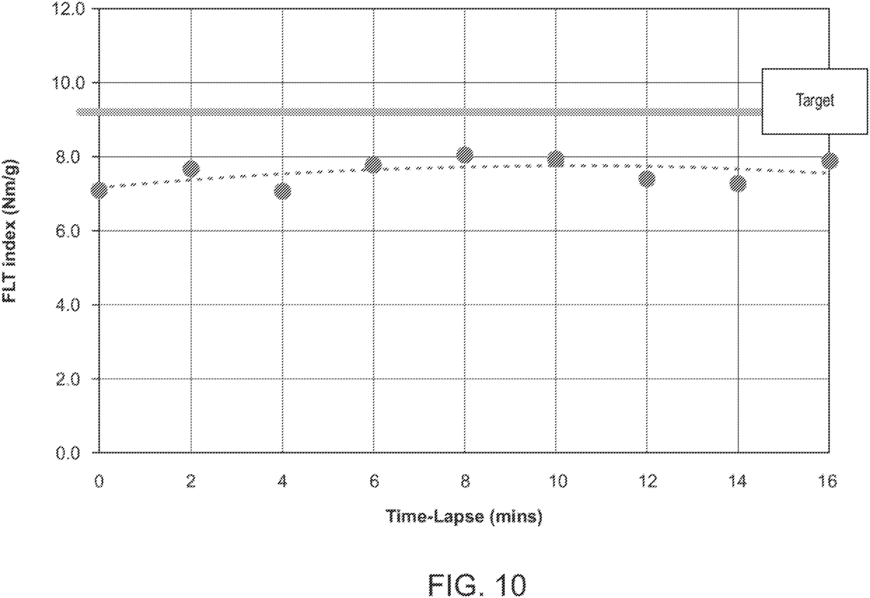

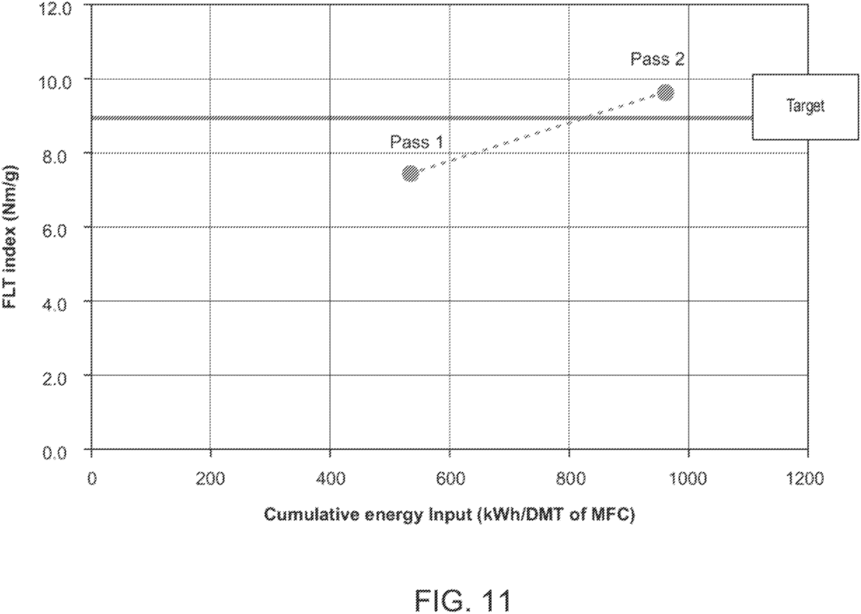

The dry, powdered mixture was also pre-wetted in a mixing tank with a moderate shear-head impeller, meant to mimic the effect of using a Cowles-blade mixer. The FLT results were much improved as seen in FIG. 10 below, but still insufficient. Two passes significantly increase the capital and operational cost of the process as seen in FIG. 11.

### Example 9: Inventive Trial Example

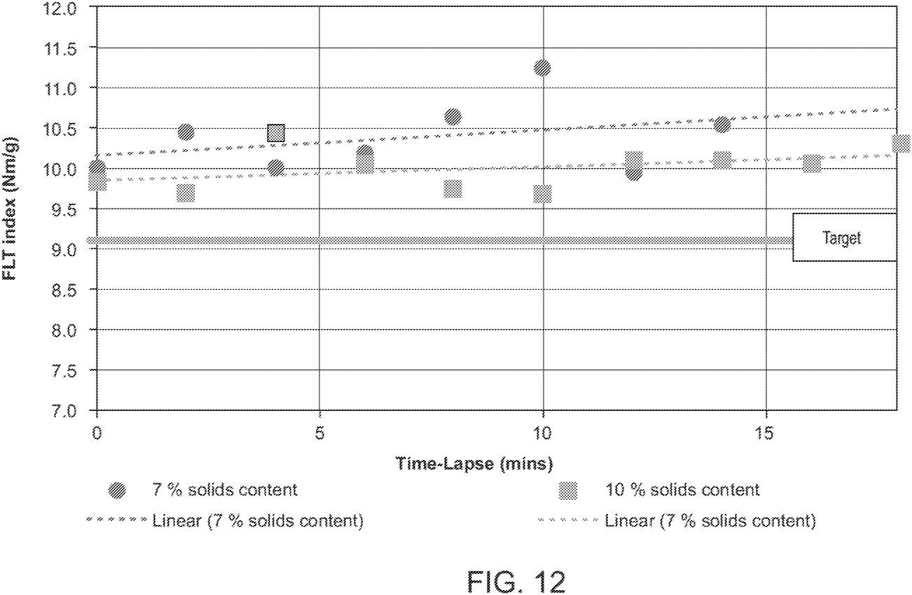

The system depicted in the flowsheet aims to improve the efficiency of the Atrex® by feeding partially wetted and suspended fibres into its high-shear counter-rotating chambers. The Trigonal® SM180 and Cowles-blade mixer act as low-cost pre-wetting devices, while the hydrocyclone improves the efficiency of the pre-wetting stage by separating unwetted components from the flow stream. The fibre-mineral component that has been wetted and disintegrated travels into the Atrex® high-shear zones as shown in FIG. 12.

The system of Example 9: Trial sheet demonstrates a process for re-dispersing dry, powdered MFC using a combination of equipment that results in a lower capital and operating cost than when used individually. The performance, in terms of tensile strength and apparent viscosity, are comparable as shown in Table 2 below.

TABLE 2

| Process | Energy Input kWh/DMT of MFC | # of Passes - | Apparent Viscosity mPa.s | FLT Strength Nm/g | Malvern D30 µm | Malvern D50 µm | Malvern D90 µm |
|---|---|---|---|---|---|---|---|
| Never dried Slurry | N/A | N/A | ≥1000 | ≥9.0 | 80 | 158 | 526 |
| FL MDU Only (Batch) | 2409 | 18 | 600 | 4.6 | 58 | 125 | 442 |
| 12″ Sprout Refiner Only (Batch) | 2840 | 15 | 1460 | 8.8 | - | - | - |
| SM180 Trigonal® Only (Batch) | 1808 | 18 | 1080 | 8.8 | 37 | 78 | 332 |
| Atrex® Only 6-ring (Batch) | 1052 | 3 | 1360 | 10.2 | 28 | 61 | 284 |
| Atrex® w/ Pre-wettng 8-ring | 962 | 2 | 1040 | 9.7 | 26 | 58 | 288 |
| Proposed Continuous Process Flowsheet | 659 | 1 | 1056 | 10.0 | 29 | 66 | 321 |

The system of Example 9: Trial 1 combines low and relatively high capital equipment in order to maximise the efficiency of re-dispersing the powdered mixture while minimising the overall cost. The closed-circuit operation of the wetting stage with the Trigonal® SM180 allows a low energy, high throughput cost-effective treatment of the slurry before the Atrex®. The Atrex®’s power consumption requirements and throughput limitations for generating very high shear-rates are diminished under a single pass operation. Therefore, integrating the equipment together provides an overall cost-effective treatment of the dry, powdered MFC to produce a slurry at the customer site with the same tensile strength properties of the never-dried slurry.

References discussed in the application are incorporated by reference in their entirety.

All patents, patent applications and publications cited herein are hereby incorporated by reference in their entirety. The disclosures of these publications in their entireties are hereby incorporated by reference into this application. The disclosures of each and every patent, patent application, publication, and accession number cited herein are hereby incorporated herein by reference in their entirety.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

The foregoing embodiments and advantages are merely exemplary and are not to be construed as limiting the present invention. The present disclosures can be readily applied to other types of methods. Also, the description of the embodiments of the present invention is intended to be illustrative and not to limit the scope of the claims. Many alternatives, modifications, and variations will be apparent to those skilled in the art.

The various embodiments described in this specification can be combined to provide further embodiments. Aspects of the embodiments can be modified, if necessary to employ concepts of the various patents, applications and publications to provide yet further embodiments.

While the present disclosure has been disclosed with reference to various embodiments, it is apparent that other embodiments and variations of these may be devised by others skilled in the art without departing from the true spirit and scope of the disclosure. The appended claims are intended to be construed to include all such embodiments and equivalent variations. The foregoing written specification is considered to be sufficient to enable one skilled in the art to practice the embodiments.

The foregoing description and Examples detail certain embodiments and describes the best mode contemplated by the inventors. It will be appreciated, however, that no matter how detailed the foregoing may appear in text, the embodiment may be practiced in many ways and should be construed in accordance with the appended claims and any equivalents thereof

1. A method for the re-dispersion of an essentially-dried or partially-dried and, optionally, pulverized, composition comprising microfibrillated cellulose and, optionally, one or more inorganic particulate material; the method comprising the steps of:
(a) providing a quantity of a dispersing liquid to a mixing tank through a first inlet; wherein the mixing tank comprises a moderate-shear mixing apparatus comprising a shear-head impeller and; wherein the mixing tank further comprises an outlet, and a first pump attached to the outlet;
(b) providing a quantity of essentially-dried or partially-dried and, optionally, pulverized, composition comprising microfibrillated cellulose and, optionally, one or more inorganic particulate material, to the mixing tank through the first inlet in sufficient quantity to yield a liquid slurry at a solids content of from about 0.5 wt% to about 5 wt% fibre solids;
(c) mixing the liquid slurry under moderate-shear conditions via the mixing apparatus to partially de-agglomerate the liquid slurry to form a flowable slurry;
(d) pumping the flowable slurry via the pump attached to the first outlet of the mixing tank to an inlet of a first stage high-shear rotor-stator apparatus further comprising an outlet, and a pump attached to the outlet; wherein the inlet of the first stage high-shear rotor-stator apparatus is in communication with the outlet of the mixing tank; wherein the flowable slurry is subjected to high-shear mixing to form a substantially homogenous suspension;
(e) pumping the substantially homogenous suspension from the outlet of the first stage high-shear rotor-stator apparatus to an inlet of a second stage high-shear apparatus, selected from a rotor-rotor apparatus, a second high-shear rotor-stator apparatus, a colloid mill, an ultrafine grinding apparatus, or a refiner, wherein the rotor-rotor apparatus comprises counter-rotating rings, for subjecting the substantially homogenous suspension to additional high-shear processing to produce a uniform re-dispersed suspension of microfibrillated cellulose and, optionally, one or more inorganic particulate material; wherein the tensile index of the microfibrillated cellulose is comparable to the tensile index of a comparable never-dried suspension of microfibrillated cellulose and, optionally, one or more inorganic particulate material; and
(h) collecting the re-dispersed suspension of microfibrillated cellulose and, optionally, one or more inorganic particulate material in a suitable holding vessel for further end-use applications.

2. The method according to claim 1, further comprising a hydrocyclone following the rotor-stator apparatus, wherein the hydrocyclone comprises an inlet, a first hydrocyclone outlet, and a second hydrocyclone outlet; wherein the hydrocyclone separates the substantially homogenous suspension into (i) a sheared fine particle stream and (ii) an under-sheared coarse particle stream; pumping the under-sheared coarse particle stream from the first hydrocyclone outlet to a second inlet of the mixing apparatus to permit recirculation and remixing of the under-sheared coarse particle stream with the flowable slurry in the mixing tank; flowing the fine particle stream from the second outlet of the hydrocyclone to an inlet of the second stage high-shear apparatus, selected from a rotor-rotor apparatus, a second high-shear rotor-stator apparatus, a colloid mill, an ultrafine grinding apparatus, or a refiner, wherein the rotor-rotor apparatus comprises counter-rotating rings, for subjecting the substantially homogenous suspension to additional high-shear processing.

3. The method according to claim 1 or claim 2, wherein the composition of microfibrillated cellulose further comprises one or more inorganic particulate material.

4. The method according to claim 1 or claim 2 wherein the essentially-dried or partially-dried composition comprising microfibrillated cellulose and, optionally, one or more inorganic particulate material is pulverized.

5. The method according to claim 3, wherein the essentially-dried or partially-dried composition comprising microfibrillated cellulose and one or more inorganic particulate material is pulverized.

6. The method according to claim 1 or claim 2, wherein the method is a continuous process, semi-continuous process or batch process.

7. The method according to claim 3, wherein the method is a continuous process, semi-continuous process or batch process.

8. The method according to claim 1 or claim 2, wherein the dispersing liquid is water.

9. The method according to claim 3, wherein the dispersing liquid is water.

10. The method according to claim 1 or claim 2, wherein the liquid composition of microfibrillated cellulose is about 0.5 wt% to about 2.5 wt% fibre solids.

11. The method according to claim 3, wherein the liquid composition of microfibrillated cellulose is about 0.5 wt% to about 2.5 wt% fibre solids.

12. The method according to claim 1 or claim 2, wherein the liquid composition of microfibrillated cellulose is about 0.75 wt% fibre solids.

13. The method according to claim 3, wherein the liquid composition of microfibrillated cellulose is about 0.75 wt% fibre solids.

14. The method according to claim 1 or claim 2, wherein the liquid composition of microfibrillated cellulose is about 1 wt% fibre solids.

15. The method according to claim 3, wherein the liquid composition of microfibrillated cellulose is about 1 wt% fibre solids.

16. The method according to claim 1 or claim 2, wherein the liquid composition of microfibrillated cellulose is about 1.25 wt% fibre solids.

17. The method according to claim 3, wherein the liquid composition of microfibrillated cellulose is about 1.25 wt% fibre solids.

18. The method according to claim 1 or claim 2, wherein the liquid composition of microfibrillated cellulose is about 1.5 wt% fibre solids.

19. The method according to claim 3, wherein the liquid composition of microfibrillated cellulose is about 1.5 wt% fibre solids.

20. The method according to claim 1 or claim 2, wherein the liquid composition of microfibrillated cellulose is about 1.75 wt% fibre solids.

21. The method according to claim 3, wherein the liquid composition of microfibrillated cellulose is about 1.75 wt% fibre solids.

22. The method according to claim 1 or claim 2, wherein the liquid composition of microfibrillated cellulose is about 2 wt% fibre solids.

23. The method according to claim 3, wherein the liquid composition of microfibrillated cellulose is about 2 wt% fibre solids.

24. The method according to claim 1 or claim 2, wherein the liquid composition of microfibrillated cellulose is about 2.5 wt% fibre solids.

25. The method according to claim 3, wherein the liquid composition of microfibrillated cellulose is about 2.5 wt% fibre solids.

26. The method according to claim 1 or claim 2, wherein the liquid composition of microfibrillated cellulose is about 3 wt% fibre solids.

27. The method according to claim 3, wherein the liquid composition of microfibrillated cellulose is about 3 wt% fibre solids.

28. The method according to claim 1 or claim 2, wherein the liquid composition of microfibrillated cellulose is about 4 wt% fibre solids.

29. The method according to claim 3, wherein the liquid composition of microfibrillated cellulose is about 4 wt% fibre solids.

30. The method according to claim 1 or claim 2, wherein the liquid composition of microfibrillated cellulose is about 5 wt% fibre solids.

31. The method according to claim 3, wherein the liquid composition of microfibrillated cellulose is about 5 wt% fibre solids.

32. The method according to claim 1 or claim 2, wherein the microfibrillated cellulose may be prepared from a chemical pulp, or a chemithermomechanical pulp, or a mechanical pulp, or a recycled pulp, or a paper broke pulp, or a papermill waste stream, or waste from a papermill, or a combination thereof.

33. The method according to claim 3, wherein the microfibrillated cellulose may be prepared from a chemical pulp, or a chemithermomechanical pulp, or a mechanical pulp, or a recycled pulp, or a paper broke pulp, or a papermill waste stream, or waste from a papermill, or a combination thereof.

34. The method according to claim 3, wherein the one or more inorganic particulate material comprises an alkaline earth metal carbonate or sulphate, a hydrous kandite clay, an anhydrous (calcined) kandite clay, talc, mica, perlite or diatomaceous earth, or combinations thereof.

35. The method according to claim 3, wherein the one or more inorganic particulate material may comprise calcium carbonate, magnesium carbonate, dolomite, bentonite, gypsum, kaolin, halloysite, ball clay, metakaolin, fully calcined kaolin, or a combination thereof.

36. The method according to claim 3, wherein the one or more inorganic particulate material comprises calcium carbonate.

37. The method according to claim 3, wherein the one or more inorganic particulate matter comprises kaolin.

38. The method according to claim 3, wherein the one or more inorganic particulate matter comprises kaolin and calcium carbonate.

39. The method according to claim 36, wherein the calcium carbonate is precipitated calcium carbonate, ground calcium carbonate or a combination thereof.

40. The method according to claim 36, wherein the calcium carbonate comprises a calcite, aragonite or vaterite structure.

41. The method according to claim 36, wherein the calcium carbonate is in a scalenohedral or rhombohedral crystal form.

42. The method according to claim 37, wherein the kaolin is hyperplaty kaolin.

43. The method according to claim 36, wherein at least about 50 wt% of the calcium carbonate has an equivalent spherical diameter of less than about 2 µm.

44. The method according to claim 37, wherein at least about 50 wt% of the kaolin has an equivalent spherical diameter of less than about 2 µm.

45. The method according to claim 36, wherein the ground calcium carbonate is limestone or marble.

46. The method according to any one of claims 1 to 3, wherein the end-use comprises a method of making paper or coating paper, paints, coatings, construction materials, ceiling tiles, material composites, or barrier coatings.

47. The method according to claim 1 or claim 2, wherein the first stage high-shear rotor-stator apparatus is selected from a Trigonal® mill, a colloid mill, an ultrafine grinding apparatus or a refiner.

48. The method according to claim 3, wherein the first stage high-shear rotor-stator apparatus is selected from a Trigonal® mill, a colloid mill, an ultrafine grinding apparatus or a refiner.

49. The method according to claim 1 or claim 2, wherein the second stage high-shear rotor-stator apparatus is selected from a rotor-rotor apparatus, a Trigonal® mill, a colloid mill, an ultrafine grinding apparatus or a refiner.

50. The method according to claim 3, wherein the second stage high-shear rotor-stator apparatus is selected from a rotor-rotor apparatus, a Trigonal® mill, a colloid mill, an ultrafine grinding apparatus or a refiner.

51. A transportable system (1) for re-dispersing an essentially-dried or partially-dried and, optionally, pulverized composition comprising microfibrillated cellulose and, optionally, one or more inorganic particulate material in a liquid medium to form a liquid composition, comprising: a mixing tank (20) comprising a mixing apparatus (21) comprising a shear-head impeller (22); wherein the mixing tank (20) comprises a first mixing tank inlet (24) for reception of a liquid slurry of microfibrillated cellulose and, optionally, one or more inorganic particulate material and a mixing tank outlet (26) comprising a pump (27); a first stage high-shear rotor-stator apparatus (30) comprising a rotor-stator inlet (31) connected to the mixing tank outlet (26) and a rotor-stator outlet (32); a second stage high-shear apparatus (50) selected from a rotor-rotor apparatus, a Trigonal® mill, a colloid mill, an ultra-fine grinding apparatus or a refiner; wherein the second stage high-shear apparatus (50) comprises a second stage high-shear inlet (52) connected to the first stage high-shear rotor-stator outlet and an outlet (53); and a storage tank (60) comprising a storage tank inlet (61) connected to the rotor-rotor outlet (53).

52. The system according to claim 51, further comprising a hydrocyclone (40) comprising a hydrocyclone inlet (41), a first hydrocyclone outlet (42), and a second hydrocyclone outlet (43); wherein the hydrocyclone inlet (41) is connected to the rotor-stator outlet (32) of the rotor-stator apparatus; wherein the hydrocyclone separates the slurry of microfibrillated cellulose and, optionally, one or more inorganic particulate material into a sheared fine particle stream and an under-sheared coarse particle stream, wherein the first hydrocyclone outlet (42) is connected to a second inlet (25) of the mixing tank (20) for returning the under-sheared coarse particle stream to the mixing tank (20); wherein the fine particle stream is flowed via the second hydrocyclone outlet (43) to the second stage high-shear inlet (52).

53. The system according to claim 51 or claim 52, wherein the essentially-dried or partially-dried and, optionally, pulverized composition comprising microfibrillated cellulose further comprises one or more inorganic particulate material.

54. The system according to claim 51 or claim 52 wherein the essentially-dried or partially-dried and, optionally, pulverized composition comprising microfibrillated cellulose further comprises one or more inorganic particulate material is pulverized.

55. The system according to claim 53, wherein the essentially-dried or partially-dried and, optionally, pulverized composition comprising microfibrillated cellulose further comprises one or more inorganic particulate material is pulverized.

56. The system according to claim 51 or claim 52, wherein the liquid medium is water.

57. The system according to claim 53, wherein the liquid medium is water.

58. The system according to claim 51 or claim 52, wherein the liquid composition of microfibrillated cellulose is about 0.5 wt% to about 5 wt% fibre solids.

59. The system according to claim 53, wherein the liquid composition of microfibrillated cellulose is about 0.5 wt% to about 5 wt% fibre solids.

58. The system according to claim 50 or claim 52, wherein the liquid composition is about 0.75 wt% fibre solids.

60. The system according to claim 53, wherein the liquid composition is about 0.75 wt% fibre solids.

62. The system according to claim 51 or claim 52, wherein the liquid composition is about 1 wt% fibre solids.

63. The system according to claim 53, wherein the liquid composition is about 1 wt% fibre solids.

64. The system according to claims 51 or 52, wherein the liquid composition is about 1.25 wt% fibre solids.

65. The system according to claim 53, wherein the liquid composition is about 1.25 wt% fibre solids.

66. The system according to claim 51 or claim 52, wherein the liquid composition is about 1.5 wt% fibre solids.

67. The system according to claim 53, wherein the liquid composition is about 1.5 wt% fibre solids.

68. The system according to claim 51 or claim 52, wherein the liquid composition is about 1.75 wt% fibre solids.

69. The system according to claim 53, wherein the liquid composition is about 1.75 wt% fibre solids.

70. The system according claim 51 or claim 52, wherein the liquid composition is about 2 wt% fibre solids.

71. The system according claim 53, wherein the liquid composition is about 2 wt% fibre solids.

72. The system according to claim 51 or claim 52, wherein the liquid composition is about 2.5 wt% fibre solids.

73. The system according to claim 53, wherein the liquid composition is about 2.5 wt% fibre solids.

74. The system according to claim 51 or claim 52, wherein the liquid composition is about 3 wt% fibre solids.

75. The system according to claim 53, wherein the liquid composition is about 3 wt% fibre solids.

76. The system according to claim 51 or claim 52,, wherein the liquid composition is about 4 wt% fibre solids.

77. The system according to claim 53, wherein the liquid composition is about 4 wt% fibre solids.

78. The system according to claim 51 or claim 52,, wherein the liquid composition is about 5 wt% fibre solids.

79. The system according to claim 53, wherein the liquid composition is about 5 wt% fibre solids.

80. The system according to claim 51 or claim 52,, wherein the microfibrillated cellulose may be prepared from a chemical pulp, or a chemithermomechanical pulp, or a mechanical pulp, or a recycled pulp, or a paper broke pulp, or a papermill waste stream, or waste from a papermill, or a combination thereof.

81. The system according to claim 53, wherein the microfibrillated cellulose may be prepared from a chemical pulp, or a chemithermomechanical pulp, or a mechanical pulp, or a recycled pulp, or a paper broke pulp, or a papermill waste stream, or waste from a papermill, or a combination thereof.

82. The system according to claim 53, wherein the one or more inorganic particulate material comprises an alkaline earth metal carbonate or sulphate, a hydrous kandite clay, an anhydrous (calcined) kandite clay, talc, mica, perlite or diatomaceous earth, or combinations thereof.

83. The system according to claim 53, wherein the one or more inorganic particulate material may comprise calcium carbonate, magnesium carbonate, dolomite, gypsum, kaolin, halloysite, ball clay, metakaolin, fully calcined kaolin, or a combinations thereof.

84. The system according to claim 53, wherein the one or more inorganic particulate material may comprise calcium carbonate.

85. The system according to claim 53, wherein the one or more inorganic particulate matter may comprise kaolin.

86. The system according to claim 53, wherein the one or more inorganic particulate matter may comprise kaolin and calcium carbonate.

87. The system according to claim 84, wherein the calcium carbonate is precipitated calcium carbonate, ground calcium carbonate or a combination thereof.

88. The system according to claim 84, wherein the calcium carbonate comprises a calcite, aragonite or vaterite structure.

89. The system according to claim 84, wherein the calcium carbonate is in a scalenohedral or rhombohedral crystal form.

90. The system according to claim 85, wherein the kaolin is hyperplaty kaolin.

91. The system according to claim 84, wherein at least about 50 wt% of the calcium carbonate has an equivalent spherical diameter of less than about 2 µm.

92. The system according to 85, wherein at least about 50 wt% of the kaolin has an equivalent spherical diameter of less than about 2 µm.

93. The system according to claim 87, wherein the ground calcium carbonate is limestone or marble.

94. The system according to claim 51 or claim 52,, wherein the first stage high-shear rotor-stator apparatus is selected from a Trigonal® mill, a colloid mill, an ultrafine grinding apparatus or a refiner.

95. The system according to claim 53, wherein the first stage high-shear rotor-stator apparatus is selected from a Trigonal® mill, a colloid mill, an ultrafine grinding apparatus or a refiner.

96. The system according to claim 51 or claim 52,, wherein the second stage high-shear rotor-stator apparatus is selected from a rotor-rotor apparatus, a Trigonal® mill, a colloid mill, an ultrafine grinding apparatus or a refiner.

97. The method according to claim 53, wherein the second stage high-shear rotor-stator apparatus is selected from a rotor-rotor apparatus, a Trigonal® mill, a colloid mill, an ultrafine grinding apparatus or a refiner.

98. A method for the re-dispersion of an essentially-dried or partially-dried and, optionally, pulverized, composition comprising microfibrillated cellulose and, optionally, one or more inorganic particulate material, the method comprising the steps of:
(a) flowing a liquid medium comprising microfibrillated cellulose and, optionally, one or more inorganic particulate material obtained from essentially-dried or partially-dried microfibrillated cellulose and, optionally, one or more inorganic particulate material, to a moderate-shear mixing apparatus comprising a shear-head impeller to form a liquid slurry comprising microfibrillated cellulose and, optionally, one or more inorganic particulate material;
(b) flowing the liquid slurry to a first stage high-shear rotor-stator apparatus, wherein the liquid slurry is subjected to high-shear mixing to form a substantially homogenous suspension;
(c) flowing the substantially homogeneous suspension to a second stage high-shear apparatus selected from a rotor-rotor apparatus, a second stage high-shear rotor-stator apparatus, a colloid mill, an ultrafine grinding apparatus, or a refiner, wherein the rotor-rotor apparatus comprises counter-rotating rings, for subjecting the substantially homogenous suspension to high-shear processing to produce a uniform re-dispersed suspension of microfibrillated cellulose and, optionally, one or more inorganic particulate material; wherein the tensile properties of the microfibrillated cellulose are comparable to the tensile properties of a comparable never-dried suspension of microfibrillated cellulose and, optionally, one or more inorganic particulate material; and
(d) collecting the re-dispersed suspension of microfibrillated cellulose and, optionally one or more inorganic particulate material, in a suitable holding vessel for further end-use applications.

99. The method according to claim 98, wherein the substantially homogeneous suspension is flowed to a hydrocyclone, wherein the substantially homogenous suspension is separated into an undersheared coarse particle stream and a sheared fine particle stream, wherein the undersheared coarse particle stream is recirculated to the moderate shear mixing apparatus and the sheared fine particle stream is flowed to the second high-shear rotor-stator apparatus, a colloid mill, an ultrafine grinding apparatus, or a refiner.

100. The method according to claim 98 or claim 99, wherein the composition of microfibrillated cellulose further comprises one or more inorganic particulate material.

101. The method according to claim 98 or 99, wherein the essentially-dried or partially-dried and, optionally, pulverized, composition comprising microfibrillated cellulose and, optionally, one or more inorganic particulate material is pulverized.

102. The method according to claim 99, wherein the essentially-dried or partially-dried composition comprising microfibrillated cellulose and one or more inorganic particulate material is pulverized.

103. The method according to claim 98 or claim 99, wherein the method is a continuous process, semi-continuous process or batch process.

104. The method according to claim 100, wherein the method is a continuous process, semi-continuous process or batch process.

105. The method according to claim 98 or claim 99, wherein the dispersing liquid is water.

106. The method according to claim 100, wherein the dispersing liquid is water.

107. The method according to claim 98 or claim 99, wherein the liquid composition of microfibrillated cellulose is about 0.5 wt% to about 2.5 wt% fibre solids.

108. The method according to claim 100, wherein the liquid composition of microfibrillated cellulose is about 0.5 wt% to about 2.5 wt% fibre solids.

109. The method according to claim 98 or claim 99, wherein the liquid composition is about 0.75 wt% fibre solids.

110. The method according to claim 100, wherein the liquid composition is about 0.75 wt% fibre solids.

111. The method according to claim 98 or 99, wherein the liquid composition is about 1 wt% fibre solids.

112. The method according to claim 100, wherein the liquid composition is about 1 wt% fibre solids.

113. The method according to claim 98 or claim 99, wherein the liquid composition is about 1.25 wt% fibre solids.

114. The method according to claim 99, wherein the liquid composition is about 1.25 wt% fibre solids.

115. The method according to claim 98 or claim 99, wherein the liquid composition is about 1.5 wt% fibre solids.

116. The method according to claim 100, wherein the liquid composition is about 1.5 wt% fibre solids.

117. The method according to claim 98 or claim 99, wherein the liquid composition is about 1.75 wt% fibre solids.

118. The method according to claim 100, wherein the liquid composition is about 1.75 wt% fibre solids.

119. The method according to claim 98 or claim 99, wherein the liquid composition is about 2 wt% fibre solids.

120. The method according to claim 100, wherein the liquid composition is about 2 wt% fibre solids.

121. The method according to claim 98 or claim 99, wherein the liquid composition is about 2.5 wt% fibre solids.

122. The method according to claim 100, wherein the liquid composition is about 2.5 wt% fibre solids.

123. The method according to claim 98 or claim 99, wherein the liquid composition is about 3 wt% fibre solids.

124. The method according to claim 100, wherein the liquid composition is about 3 wt% fibre solids.

125. The method according to claim 98 or claim 99, wherein the liquid composition is about 4 wt% fibre solids.

126. The method according to claim 100, wherein the liquid composition is about 4 wt% fibre solids.

127. The method according to claim 98 or claim 99, wherein the liquid composition is about 5 wt% fibre solids.

128. The method according to claim 100, wherein the liquid composition is about 5 wt% fibre solids.

129. The method according to claim 98 or claim 99, wherein the microfibrillated cellulose may be prepared from a chemical pulp, or a chemithermomechanical pulp, or a mechanical pulp, or a recycled pulp, or a paper broke pulp, or a papermill waste stream, or waste from a papermill, or a combination thereof.

130. The method according to claim 100, wherein the microfibrillated cellulose may be prepared from a chemical pulp, or a chemithermomechanical pulp, or a mechanical pulp, or a recycled pulp, or a paper broke pulp, or a papermill waste stream, or waste from a papermill, or a combination thereof.

131. The method according to claim 100, wherein the one or more inorganic particulate material comprises an alkaline earth metal carbonate or sulphate, a hydrous kandite clay, an anhydrous (calcined) kandite clay, talc, mica, perlite or diatomaceous earth, or combinations thereof.

132. The method according to claim 100, wherein the one or more inorganic particulate material may comprise calcium carbonate, magnesium carbonate, dolomite, gypsum, kaolin, halloysite, ball clay, metakaolin, fully calcined kaolin, or a combinations thereof.

133. The method according to claim 98, wherein the one or more inorganic particulate material comprises calcium carbonate.

134. The method according to claim 100, wherein the one or more inorganic particulate matter comprises kaolin.

135. The method according to claim 100, wherein the one or more inorganic particulate matter may comprise kaolin and calcium carbonate.

136. The method according to claim 133, wherein the calcium carbonate is precipitated calcium carbonate, ground calcium carbonate or a combination thereof.

137. The method according to claim 133, wherein the calcium carbonate comprises a calcite, aragonite or vaterite structure.

138. The method according to claim 133, wherein the calcium carbonate is in a scalenohedral or rhombohedral crystal form.

139. The method according to claim 134, wherein the kaolin is hyperplaty kaolin.

140. The method according to claim 133, wherein at least about 50 wt% of the calcium carbonate has an equivalent spherical diameter of less than about 2 µm.

141. The method according to claim 134, wherein at least about 50 wt% of the kaolin has an equivalent spherical diameter of less than about 2 µm.

142. The method according to claim 133, wherein the ground calcium carbonate is limestone or marble.

143. The method according to claim 98 or claim 99, wherein the end-use comprises a method of making paper or coating paper, paints, coatings, construction materials, ceiling tiles, material composites, or barrier coatings.

144. The method according to claim 100, wherein the end-use comprises a method of making paper or coating paper, paints, coatings, construction materials, ceiling tiles, material composites, barrier coatings.

145. The method according to claim 98 or claim 99, wherein the first stage high-shear rotor-stator apparatus is selected from a Trigonal® mill, a colloid mill, an ultrafine grinding apparatus or a refiner.

146. The method according to claim 100, wherein the first stage high-shear rotor-stator apparatus is selected from a Trigonal® mill, a colloid mill, an ultrafine grinding apparatus or a refiner.

147. The method according to claim 98 or claim 99, wherein the second stage high-shear rotor-stator apparatus is selected from a rotor-rotor apparatus, a Trigonal® mill, a colloid mill, an ultrafine grinding apparatus or a refiner.

148. The method according to claim 100, wherein the second stage high-shear rotor-stator apparatus is selected from a rotor-rotor apparatus, a Trigonal® mill, a colloid mill, an ultrafine grinding apparatus or a refiner.
